(19) United States
(12) Patent Application Publication
(10) Pub. No.: US 2011/0293185 A1
(43) Pub. Date: Dec. 1, 2011

(54) HYBRID SYSTEM FOR IDENTIFYING PRINTED PAGE

(75) Inventors: Kia Silverbrook, Balmain (AU); Jonathon Leigh Napper, Balmain (AU); Robert Dugald Gates, Balmain (AU); Paul Lapstun, Balmain (AU)

(73) Assignee: Silverbrook Research Pty Ltd

(21) Appl. No.: 13/050,935

(22) Filed: Mar. 18, 2011

Related U.S. Application Data
(60) Provisional application No. 61/350,013, filed on May 31, 2010.
(60) Provisional application No. 61/393,927, filed on Oct. 17, 2010.
(60) Provisional application No. 61/422,502, filed on Dec. 13, 2010.

(51) Int. Cl. G06K 9/18

(52) U.S. Cl. 382/182

(57) ABSTRACT

A hybrid system for identifying a printed page. The system includes: (i) the printed page having human-readable content and a coding pattern printed in every interstitial space between portions of human-readable content, the coding pattern being either absent from the human-readable content or unreadable when superimposed with the human-readable content; and (ii) a handheld device for overlaying and contacting the printed page. The handheld device includes: a camera for capturing page fragment images; and a processor configured for: decoding the coding pattern and determining the page identity in the event that the coding pattern is visible in and decodable from the captured page fragment image; and otherwise initiating OCR or SIFT techniques to identify the page.

### FIELD OF INVENTION

The present invention relates to interactions with printed substrates using a mobile phone or similar device. It has been developed primarily for improving the versatility of such interactions, especially in systems which minimize the use of special coding patterns or inks.

### COPENDING

The following applications have been filed by the Applicant simultaneously with the present application:

| | | | | |
|---|---|---|---|---|
| NPU023US | NPU025US | NPU026US | NPU027US | NPU028US |
| NPU029US | NPU030US | | | |

The disclosures of these co-pending applications are incorporated herein by reference. The above applications have been identified by their filing docket number, which will be substituted with the corresponding application number, once assigned.

### CROSS REFERENCES

| | | | | |
|---|---|---|---|---|
| 6,982,798 | 7,148,345 | 7,406,445 | 6,832,717 | 6,870,966 |
| 6,788,293 | 6,946,672 | 10/778,056 | 11/193,482 | 11/495,823 |
| 6,808,330 | 12/025,746 | 12/025,762 | 12/178,619 | 12/539,579 |
| 12/539,588 | 12/694,264 | 12/694,269 | 12/694,271 | 12/694,274 |
| 7,762,453 | 11/754,310 | 12/015,507 | 12/015,508 | 7,878,404 |
| 12/178,641 | 12/750,449 | 12/178,610 | 12/178,637 | 12/477,863 |

### BACKGROUND

The Applicant has previously described a system (“Netpage”) enabling users to access information from a computer system via a printed substrate e.g. paper. In the Netpage system, the substrate has a coding pattern printed thereon, which is read by an optical sensing device when the user interacts with the substrate using the sensing device. A computer receives interaction data from the sensing device and uses this data to determine what action is being requested by the user. For example, a user may make handwritten input onto a form or indicate a request for information via a printed hyperlink. This input is interpreted by the computer system with reference to a page description corresponding to the printed substrate.

Various forms of Netpage readers have been described for use as the optical sensing device. For example, the Netpage reader may be in the form of a Netpage Pen as described in U.S. Pat. No. 6,870,966; U.S. Pat. No. 6,474,888; U.S. Pat. No. 6,788,982; US 2007/0025805; and US 2009/0315862, the contents of each of which are incorporated herein by reference. Another form of Netpage reader is a Netpage Viewer, as described in U.S. Pat. No. 6,788,293, the contents of which is incorporated herein by reference. In the Netpage Viewer, an opaque touch-sensitive screen provides users with a virtually transparent view of an underlying page. The Netpage Viewer reads the Netpage coding pattern using an optical image sensor and retrieves display data corresponding to the area of the page underlying the screen using the page identity and coordinate position encoded in the Netpage coding pattern.

It would be desirable to provide users with the functionality of a Netpage Viewer without the same degree of reliance on the Netpage coding pattern. It would be further desirable to provide users with the functionality of a Netpage Viewer via ubiquitous smartphones e.g. an iPhone or Android phone.

### SUMMARY OF INVENTION

In a first aspect, there is provided a method of identifying a physical page containing printed text from a plurality of page fragment images captured by a camera, the method comprising:

placing a handheld electronic device in contact with a surface of the physical page, the device comprising a camera and a processor;

moving the device across the physical page and capturing the plurality of page fragment images at a plurality of different capture points using the camera;

measuring a displacement or direction of movement;

performing OCR on each captured page fragment image to identify a plurality of glyphs in a two-dimensional array;

creating a glyph group key for each page fragment image, the glyph group key containing n×m glyphs, where n and m are integers from 2 to 20;

looking up each created glyph group key in an inverted index of glyph group keys;

comparing a displacement or direction between glyph group keys in the inverted index with a measured displacement or direction between the capture points for corresponding glyph group keys created using the OCR; and

identifying a page identity corresponding to the physical page using the comparison.

The invention according to the first aspect advantageously improves the accuracy and reliability of OCR techniques for page identification, particularly in devices having a relatively small field of view which are unable to capture a large area of text. A small field of view is inevitable when a smartphone lies flat against or hovers close to (e.g. within 10 mm) a printed surface.

Optionally, the handheld electronic device is substantially planar and comprises a display screen.

Optionally, a plane of the handheld electronic device is parallel with a surface of the physical page, such that a pose of the camera is fixed and normal relative to the surface.

Optionally, each captured page fragment image has substantially consistent scale and illumination with no perspective distortion.

Optionally, a field of view of the camera has an area of less than about 100 square millimeters. Optionally, the field of view has a diameter of 10 mm or less, or 8 mm or less.

Optionally, the camera has an object distance of less than 10 mm.

Optionally, the method comprises the step of retrieving a page description corresponding to the page identity.

Optionally, the method comprises the step of identifying a position of the device relative to the physical page.

Optionally, the method comprises the step of comparing a fine alignment of imaged glyphs with a fine alignment of glyphs described by a retrieved page description.

Optionally, the method comprises the step of employing a scale-invariant feature transform (SIFT) technique to augment the method of identifying the page.

Optionally, the displacement or direction of movement is measured using at least one of: an optical mouse technique; detecting motion blur; doubly integrating accelerometer signals; and decoding a coordinate grid pattern.

Optionally, the inverted index comprises glyph group keys for skewed arrays of glyphs.

Optionally, the method comprises the step of utilizing contextual information to identify a set of candidate pages.

Optionally, the contextual information comprises at least one of: an immediate page or publication with which a user has been interacting; a recent page or publication with which a user has been interacting; publications associated with a user; recently published publications; publication printed in a user's preferred language; publications associated with a geographic location of a user.

In a second aspect, there is provided a system for identifying a physical page containing printed text from a plurality of page fragment images, the system comprising:

(A) a handheld electronic device configured for placement in contact with a surface of the physical page, the device comprising:

a camera for capturing a plurality of page fragment images at a plurality of different capture points when the device is moved across the physical page;

motion sensing circuitry for measuring a displacement or a direction of movement; and

a transceiver;

(B) a processing system configured for:

performing OCR on each captured page fragment image to identify a plurality of glyphs in a two-dimensional array; and
creating a glyph group key for each page fragment image, the glyph group key containing n×m glyphs, where n and m are integers from 2 to 20; and

(C) an inverted index of the glyph group keys,

wherein the processing system is further configured for:

looking up each created glyph group key in an inverted index of glyph group keys;
comparing the displacement or direction between glyph group keys in the inverted index with a measured displacement or direction between the capture points for corresponding glyph group keys created using the OCR; and
identifying a page identity corresponding to the physical page using the comparison.

Optionally, the processing system is comprised of:
a first processor contained in the handheld electronic device and a second processor contained in a remote computer system.

Optionally, the processing system is comprised solely of a first processor contained in the handheld electronic device.

Optionally, the inverted index is stored in the remote computer system.

Optionally, the motion sensing circuitry is comprised of the camera and first processor suitably configured for sensing motion. In this scenario the motion sensing circuitry may utilize at least one of: an optical mouse technique; detecting motion blur; and decoding a coordinate grid pattern.

Optionally, the motion sensing circuitry is comprised of an explicit motion sensor, such as a pair of orthogonal accelerometers or one or more gyroscopes.

In a third aspect, there is provided a hybrid system for identifying a printed page, the system comprising:
the printed page having human-readable content and a coding pattern printed in every interstitial space between portions of human-readable content, the coding pattern identifying a page identity, the coding pattern being either absent from the portions of human-readable content or unreadable when superimposed with the human-readable content;
a handheld device for overlaying and contacting the printed page, the device comprising:

a camera for capturing page fragment images; and

a processor configured for:
decoding the coding pattern and determining the page identity in the event that the coding pattern is visible in and decodable from the captured page fragment image; and
otherwise initiating at least one of OCR and SIFT techniques to identify the page from text and/or graphic features in the captured page fragment image.

The hybrid system according to the third aspect advantageously obviates the requirement for complementary ink sets to be used for the coding pattern and the human-readable content on a page. Hence, the hybrid system is amenable to traditional analogue printing techniques whilst minimizing overall visibility of the coding pattern and potentially avoiding the use of specially-dedicated IR inks. In a conventional CMYK ink set, it is possible to dedicate the K channel to the coding pattern and print human-readable content using CMY. This is possible because black (K) ink is usually IR-absorptive and the CMY inks usually have an IR window enabling the black ink to be read through the CMY layer. However, printing the coding pattern using black ink makes the coding pattern undesirably visible to the human eye. The hybrid system according to the third aspect still makes use of a conventional CMYK ink set, but a low-luminance ink such as yellow can be used to print the coding pattern. Due to the low coverage and low-luminance of the yellow ink, the coding pattern is virtually invisible to the human eye.

Optionally, the coding pattern has less than 4% coverage on the page.

Optionally, the coding pattern is printed with yellow ink, the coding pattern being substantially invisible to a human eye by virtue of a relatively low luminance of yellow ink.

Optionally, the handheld device is a tablet-shaped device having a display screen on a first face and the camera positioned on an opposite second face, and wherein the second face is in contact with a surface of the printed page when the device overlays the page.

Optionally, a pose of the camera is fixed and normal relative to the surface when the device overlays the printed page.

Optionally, each captured page fragment image has substantially consistent scale and illumination with no perspective distortion.

Optionally, a field of view of the camera has an area of less than about 100 square millimeters.

Optionally, the camera has an object distance of less than 10 mm.

Optionally, the device is configured for retrieving a page description corresponding to the page.

Optionally, the coding pattern identifies a plurality of coordinate locations on the page and the processor is configured for determining a position of the device relative to the page.

Optionally, the coding pattern is printed only in interstitial spaces between lines of text.

Optionally, the device further comprises means for sensing motion.

Optionally, the means for sensing motion utilizes at least one of: an optical mouse technique; detecting motion blur; doubly integrating accelerometer signals; and decoding a coordinate grid pattern.

Optionally, the device is configured for moving across the page, the camera is configured for capturing a plurality of page fragment images at a plurality of different capture points, and the processor is configured for initiating an OCR technique comprising the steps of:

measuring a displacement or direction of movement using the motion sensor;

performing OCR on each captured page fragment image to identify a plurality of glyphs in a two-dimensional array;

creating a glyph group key for each page fragment image, the glyph group key containing n×m glyphs, where n and m are integers from 2 to 20;

looking up each created glyph group key in an inverted index of glyph group keys;

comparing the displacement or direction between glyph group keys in the inverted index with a measured displacement or direction between the capture points for corresponding glyph group keys created using the OCR; and

identifying the page using the comparison.

Optionally, the OCR technique utilizes contextual information to identify a set of candidate pages.

Optionally, the contextual information comprises a page identity determined from the coding pattern of a page with which a user has immediately or recently interacted.

Optionally, the contextual information comprises at least one of: publications associated with a user; recently published publications; publication printed in a user's preferred language; publications associated with a geographic location of a user.

In a further aspect, there is provided a printed page having human-readable lines of text and a coding pattern printed in every interstitial space between the lines of text, the coding pattern identifying a page identity and being printed with a yellow ink, the coding pattern being either absent from the lines of text or unreadable when superimposed with the text.

Optionally, the coding pattern identifies a plurality of coordinate locations on the page.

Optionally, the coding pattern is printed only in interstitial spaces between lines of text.

In a fourth aspect, there is provided a mobile phone assembly for magnifying a portion of a surface, the assembly comprising:

a mobile phone comprising a display screen and a camera having an image sensor; and

an optical assembly comprising:
a first mirror offset from the image sensor for deflecting an optical path substantially parallel with the surface;
a second mirror aligned with the camera for deflecting the optical path substantially perpendicular to the surface and onto the image sensor; and
a microscope lens positioned in the optical path,
   wherein the optical assembly has a thickness of less than 8 mm and is configured such that the surface is in focus when the mobile phone assembly lies flat against the surface.

The mobile phone assembly according to the fourth aspect advantageously modifies a mobile phone so that it is configured for reading a Netpage coding pattern, without impacting severely on the overall form factor of the mobile phone.

Optionally, the optical assembly is integral with the mobile phone so that the mobile phone assembly defines the mobile phone.

Optionally, the optical assembly is contained in a detachable microscope accessory for the mobile phone.

Optionally, the microscope accessory comprises a protective sleeve for the mobile phone and the optical assembly is disposed within the sleeve. Accordingly, the microscope accessory becomes part of a common accessory for mobile phones, which many users already employ.

Optionally, a microscope aperture is positioned in the optical path.

Optionally, the microscope accessory comprises an integral light source for illuminating the surface.

Optionally, the integral light source is user-selectable from a plurality of different spectra.

Optionally, an in-built flash of the mobile phone is configured as a light source for the optical assembly.

Optionally, the first mirror is partially transmissive and aligned with the flash, such that the flash illuminates the surface through the first mirror.

Optionally, the optical assembly comprises at least one phosphor for converting at least part of a spectrum of the flash.

Optionally, the phosphor is configured to convert the part of the spectrum to a wavelength range containing a maximum absorption wavelength of an ink printed on the surface.

Optionally, the surface comprises a coding pattern printed with the ink.

Optionally, the ink is IR-absorptive or UV-absorptive.

Optionally, the phosphor is sandwiched between a hot mirror and a cold mirror for maximizing conversion of the part of the spectrum to an IR wavelength range.

Optionally, the camera comprises an image sensor configured with a filter mosaic of XRGB in a ratio of 1:1:1:1, wherein X=IR or UV.

Optionally, the optical path is comprised of a plurality of linear optical paths, and wherein a longest linear optical path in the optical assembly is defined by a distance between the first and second mirrors.

Optionally, the optical assembly is mounted on a sliding or rotating mechanism for interchangeable camera and microscope functions.

Optionally, the optically assembly is configured such that a microscope function and a camera function are manually or automatically selectable.

Optionally, the mobile phone assembly further comprises a surface contact sensor, wherein the microscope function is configured to be automatically selected when the surface contact sensor senses surface contact.

Optionally, the surface contact sensor is selected from the group consisting of: a contact switch, a range finder, an image sharpness sensor, and a bump impulse sensor.

In a fifth aspect, there is provided a microscope accessory for attachment to a mobile phone having a display positioned in a first face and a camera positioned in an opposite second face, the microscope accessory comprising:
one or more engagement features for releasably attaching the microscope accessory to the mobile phone; and
an optical assembly comprising:

a first mirror positioned to be offset from the camera when the microscope accessory is attached to the mobile phone, the first mirror being configured for deflecting an optical path substantially parallel with the second face;

a second mirror positioned for alignment with the camera when the microscope accessory is attached to the mobile phone, the second mirror being configured for deflecting the optical path substantially perpendicular to the second face and onto an image sensor of the camera; and

a microscope lens positioned in the optical path,

wherein the optical assembly is matched with the camera, such that a surface is in focus when the mobile phone lies flat against the surface.

Optionally, the microscope accessory is substantially planar having a thickness of less than 8 mm.

Optionally, the microscope accessory comprises a sleeve for releasable attachment to the mobile phone.

Optionally, the sleeve is a protective sleeve for the mobile phone.

Optionally, the optical assembly is disposed within the sleeve.

Optionally, the optical assembly is matched with the camera such that the surface is in focus when the assembly is in contact with the surface.

Optionally, the microscope accessory comprises a light source for illuminating the surface

In a sixth aspect, there is provided a handheld display device having a substantially planar configuration, the device comprising:

a housing having first and second opposite faces;

a display screen disposed in the first face;

a camera comprising an image sensor positioned for receiving images from the second face;

a window defined in the second face, the window being offset from the image sensor; and

microscope optics defining an optical path between the window and the image sensor, the microscope optics being configured for magnifying a portion of a surface upon which the device is resting,

wherein a majority of the optical path is substantially parallel with a plane of the device.

Optionally, the handheld display device is a mobile phone.

Optionally, a field of view of the microscope optics has a diameter of less than 10 mm when the device is resting on the surface.

Optionally, the microscope optics comprises:

a first mirror aligned with the window for deflecting the optical path substantially parallel with the surface;

a second mirror aligned with the image sensor for deflecting the optical path substantially perpendicular to the second face and onto the image sensor; and

a microscope lens positioned in the optical path.

Optionally, the microscope lens is positioned between the first and second mirrors.

Optionally, the first mirror is larger than the second mirror.

Optionally, the first mirror is tilted at an angle of less than 25 degrees relative to the surface, thereby minimizing an overall thickness of the device.

Optionally, the second mirror is tilted at an angle of more than 50 degrees relative to the surface.

Optionally, a minimum distance from the surface to the image sensor is less than 5 mm.

Optionally, the handheld display device comprises a light source for illuminating the surface.

Optionally, the first mirror is partially transmissive and the light source is positioned behind and aligned with the first mirror.

Optionally, the handheld display device is configured such that a microscope function and a camera function are manually or automatically selectable.

Optionally, the second mirror is rotatable or slidable for selection of the microscope and camera functions.

Optionally, the handheld display device further comprises a surface contact sensor, wherein the microscope function is configured to be automatically selected when the surface contact sensor senses surface contact.

In a seventh aspect, there is provided a method of displaying an image of a physical page relative to which a handheld display device is positioned, the method comprising the steps of:

capturing an image of the physical page using an image sensor of the device;

determining or retrieving a page identity for the physical page;

retrieving a page description corresponding to the page identity;

rendering a page image based on the retrieved page description;

estimating a first pose of the device relative to the physical page by comparing the rendered page image with the captured image of the physical image;

estimating a second pose of the device relative to a user's viewpoint;

determining a projected page image for display by the device, the projected page image being determined using the rendered page image, the first pose and the second pose; and

displaying the projected page image on a display screen of the device,

wherein the display screen provides a virtual transparent viewport onto the physical page irrespective of a position and orientation of the device relative to the physical page.

The method according to the seventh aspect advantageously provides users with a richer and more realistic experience of pages downloaded to their smartphones. Hitherto, the Applicant has described a Viewer device which lies flat against a printed page and provides virtual transparency by virtue of downloaded display information, which is matched and aligned with underlying printed content. The Viewer has a fixed pose relative to the page. In the method according to the seventh aspect, the device may be held at any particular pose relative to a page, and a projected page image is displayed on the device taking into account the device-page pose and the device-user pose. In this way, the user is presented with a more realistic image of the viewed page and the experience of virtual transparency is maintained, even when the device is held above the page.

Optionally, the device is a mobile phone, such as smartphone e.g. Apple iPhone.

Optionally, the page identity is determined from textual and/or graphical information contained in the captured image

Optionally, the page identity is determined from a captured image of a barcode, a coding pattern or a watermark disposed on the physical page.

Optionally, the second pose of the device relative to the user's viewpoint is estimated by assuming the user's viewpoint is at a fixed position relative to the display screen of the device.

Optionally, the second pose of the device relative to the user's viewpoint is estimated by detecting the user via a user-facing camera of the device.

Optionally, the first pose of the device relative to the physical page is estimated by comparing perspective distorted features in the captured page image with corresponding features in the rendered page image.

Optionally, at least the first pose is re-estimated in response to movement of the device, and the projected page image is altered in response to a change in the first pose.

Optionally, the method further comprises the steps of:
estimating changes in an absolute orientation and position of the device in the world; and
updating at least the first pose using the changes.

Optionally, the changes in absolute orientation and position are estimated using at least one of: an accelerometer, a gyroscope, a magnetometer and a global positioning system.

Optionally, the displayed projected image comprises a displayed interactive element associated with the physical page and the method further comprises the step of:

interacting with the displayed interactive element.

Optionally, the interacting initiates at least one of: hyperlinking, dialing a phone number, launching a video, launching an audio clip, previewing a product, purchasing a product and downloading content.

Optionally, the interacting is an on-screen interaction via a touchscreen display.

In an eighth aspect, there is provided a handheld display device for displaying an image of a physical page relative to which the device is positioned, the device comprising:

an image sensor for capturing an image of the physical page;

a transceiver for receiving a page description corresponding to a page identity of the physical page;

a processor configured for:
rendering a page image based on the received page description;
estimating a first pose of the device relative to the physical page by comparing the rendered page image with the captured image of the physical image;
estimating a second pose of the device relative to a user's viewpoint; and
determining a projected page image for display by the device, the projected page image being determined using the rendered page image, the first pose and the second pose; and

a display screen for displaying the projected page image,

wherein the display screen provides a virtual transparent viewport onto the physical page irrespective of a position and orientation of the device relative to the physical page.

Optionally, the transceiver is configured for sending the captured image or capture data derived from the captured image to a server, the server being configured for determining the page identity and retrieving the page description using the captured image or the capture data.

Optionally, the server is configured for determining the page identity using textual and/or graphical information contained in the captured image or the capture data.

Optionally, the processor is configured for determining the page identity from a barcode or a coding pattern contained in the captured image.

Optionally, the device comprises a memory for storing received page descriptions.

Optionally, processor is configured for estimating the second pose of the device relative the user's viewpoint by assuming the user's viewpoint is at a fixed position relative to the display screen of the device.

Optionally, the device comprises a user-facing camera, and the processor is configured for estimating the second pose of the device relative the user's viewpoint by detecting the user via the user-facing camera.

Optionally, the processor is configured for estimating the first pose of the device relative to the physical page by comparing perspective distorted features in the captured page image with corresponding features in the rendered page image.

In a further aspect, there is provided a computer program for instructing a computer to perform a method of:

determining or retrieving a page identity for a physical page, the physical page having its image captured by an image sensor of a handheld display device positioned relative to the physical page;

retrieving a page description corresponding to the page identity;

rendering a page image based on the retrieved page description;

estimating a first pose of the device relative to the physical page by comparing the rendered page image with the captured image of the physical image;

estimating a second pose of the device relative to a user's viewpoint;

determining a projected page image for display by the device, the projected page image being determined using the rendered page image, the first pose and the second pose; and

displaying the projected page image on a display screen of the device,

wherein the display screen provides a virtual transparent viewport onto the physical page irrespective of a position and orientation of the device relative to the physical page.

In a further aspect, there is provided a computer-readable medium containing a set of processing instructions instructing a computer to perform a method of:

determining or retrieving a page identity for a physical page, the physical page having its image captured by an image sensor of a handheld display device positioned relative to the physical page;

retrieving a page description corresponding to the page identity;

rendering a page image based on the retrieved page description;

estimating a first pose of the device relative to the physical page by comparing the rendered page image with the captured image of the physical image;

estimating a second pose of the device relative to a user's viewpoint;

determining a projected page image for display by the device, the projected page image being determined using the rendered page image, the first pose and the second pose; and

displaying the projected page image on a display screen of the device,

wherein the display screen provides a virtual transparent viewport onto the physical page irrespective of a position and orientation of the device relative to the physical page.

In a further aspect, there is provided a computer system for identifying a physical page containing printed text, the computer system being configured for:

receiving a plurality of page fragment images captured by a camera at a plurality of different capture points on the physical page;

receiving data identifying a measured displacement or direction of the camera;

performing OCR on each captured page fragment image to identify a plurality of glyphs in a two-dimensional array;

creating a glyph group key for each page fragment image, the glyph group key containing n×m glyphs, where n and m are integers from 2 to 20;

looking up each created glyph group key in an inverted index of glyph group keys;

comparing a displacement or direction between glyph group keys in the inverted index with the measured displacement or direction between the capture points for corresponding glyph group keys created using the OCR; and

identifying a page identity corresponding to the physical page using the comparison.

In a further aspect, there is provided a computer system for identifying a physical page containing printed text, the computer system being configured for:

receiving a plurality of glyph group keys created by a handheld display device, each glyph group key being created from a page fragment image captured by a camera of the device at a respective capture point on a physical page, the glyph group key containing n×m glyphs, where n and m are integers from 2 to 20;

receiving data identifying a measured displacement or direction of the display device;

looking up each created glyph group key in an inverted index of glyph group keys;

comparing a displacement or direction between glyph group keys in the inverted index with the measured displacement or direction between the capture points for corresponding glyph group keys created by the display device; and

identifying a page identity corresponding to the physical page using the comparison.

In a further aspect, there is provided a handheld display device for identifying a physical page containing printed text, the display device comprising:
a camera for capturing a plurality of page fragment images at a plurality of different capture points when the device is moved across the physical page;
a motion sensor for measuring a displacement or a direction of movement;
a processor configured for:

performing OCR on each captured page fragment image to identify a plurality of glyphs in a two-dimensional array; and

creating a glyph group key for each page fragment image, the glyph group key containing n×m glyphs, where n and m are integers from 2 to 20; and
a transceiver configured for:

sending each created glyph group key together with data identifying a measured displacement or direction to a remote computer system, such that the computer system looks up each created glyph group key in an inverted index of glyph group keys; compares the displacement or direction between glyph group keys in the inverted index with a measured displacement or direction between the capture points for corresponding glyph group keys created by the display device; and identifies a page identity corresponding to the physical page using the comparison; and

receiving a page description corresponding to the identified page description; and a display screen for displaying a rendered page image based on the received page description.

In a further aspect, there is provided a handheld device configured for overlaying and contacting a printed page and for identifying the printed page, the device comprising:

a camera for capturing one or more page fragment images; and

a processor configured for:
decoding a printed coding pattern and determining a page identity from the coding pattern in the event that the coding pattern is visible in and decodable from the captured page fragment image; and
otherwise initiating at least one of OCR and SIFT techniques to identify the page

from text and/or graphic features in the captured page fragment image,

wherein the printed page comprises human-readable content and the coding pattern printed in every interstitial space between portions of human-readable content, the coding pattern identifying the page identity, the coding pattern being either absent from the portions of human-readable content or unreadable when superimposed with the human-readable content.

In a further aspect, there is provided a hybrid method for identifying a printed page, the method comprising the steps of:

placing a handheld device in contact with a printed page, the printed page having human-readable content and a coding pattern printed in every interstitial space between portions of human-readable content, the coding pattern identifying a page identity, the coding pattern being either absent from the portions of human-readable content or unreadable when superimposed with the human-readable content;

capturing one or more page fragment images via a camera of the handheld device; and

decoding the coding pattern and determining the page identity in the event that the coding pattern is visible in and decodable from the captured page fragment image; and

otherwise initiating at least one of OCR and SIFT techniques to identify the page from text and/or graphic features in the captured page fragment image.

In a further aspect, there is provided a method of identifying a physical page comprising a printed coding pattern, the coding pattern identifying a page identity, the method comprising the steps of:

attaching a microscope accessory to a smartphone, the microscope accessory comprising microscope optics configuring a camera of the smartphone such that the coding pattern is in focus and readable by the smartphone when the smartphone is placed in contact with the physical page;

placing the smartphone in contact with the physical page;

retrieving a software application in the smartphone, the software application comprising processing instructions for reading and decoding the coding pattern;

capturing an image of at least part of the coding pattern via the microscope accessory and smartphone camera;

decoding the read coding pattern; and

determining the page identity.

In a further aspect, there is provided a sleeve for a smartphone, the sleeve comprising microscope optics configured such that a surface is in focus when the smartphone encased in the sleeve lies flat against a surface.

Optionally, the microscope optics comprises a microscope lens mounted on a slidable tongue, wherein the slidable tongue is slidable into: a first position wherein the microscope lens is offset from an integral camera of the smartphone so as to provide a conventional camera function; and a second position wherein the microscope is aligned with the camera so as to provide a microscope function.

Optionally, the microscope optics follow a straight optical pathway from the surface to an image sensor of the smartphone.

Optionally, the microscope optics follow a folded or bent optical pathway from the surface to the image sensor.

### BRIEF DESCRIPTION OF DRAWINGS

Preferred and other embodiments of the invention will now be described, by way of non-limiting example only, with reference to the accompanying drawings, in which:

FIG. 1 is a schematic of a the relationship between a sample printed netpage and its online page description;

FIG. 2 shows an embodiment of basic netpage architecture with various alternatives for the relay device;

FIG. 3 is a perspective view of a Netpage Viewer device;

FIG. 4 shows the Netpage Viewer in contact with a surface having printed text and Netpage coding pattern;

FIG. 5 shows the Netpage Viewer in contact with the surface shown in FIG. 4 and rotated;

FIG. 6 shows a magnified portion of a fine Netpage coding pattern co-printed with 8-point text with a nominal 3 mm field of view;

FIG. 7 shows 8-point text with a 6 mm×8 mm field of view superimposed at two different locations and orientations;

FIG. 8 shows some examples of (2, 4) glyph group keys;

FIG. 9 is an object model representing occurrences of glyph groups on a document page;

FIG. 10 is a perspective view of a microscope accessory for an iPhone;

FIG. 11 shows an optical design of the microscope accessory;

FIG. 12 shows a 400 nm ray trace with a camera focus at infinity (top) and at macro focus (bottom);

FIG. 13 shows a 800 nm ray trace with a camera focus at infinity (top) and at macro focus (bottom);

FIG. 14 is an exploded view of the microscope accessory shown in FIG. 10;

FIG. 15 is a longitudinal section of a camera in the microscope accessory shown in FIG. 10;

FIG. 16 shows a microscope accessory circuit;

FIG. 17A shows a conventional RGB Bayer filter mosaic;

FIG. 17B shows a XRGB filter mosaic;

FIG. 18A is a schematic bottom view of an iPhone having a slidable microscope lens in an inactive position;

FIG. 18B is a schematic bottom view of the iPhone shown in FIG. 18A having the slidable microscope lens in an active position;

FIG. 19A shows a folded optical path for microscope optics;

FIG. 19B is a magnified view of an image-space portion of the optical path shown in FIG. 19B;

FIG. 20 is a schematic view of an integrated folded optical component placed relative to a camera in an iPhone;

FIG. 21 shows the integrated folded optical component;

FIG. 22 is a typical white LED emission spectrum from an iPhone 4 flash;

FIG. 23 shows an arrangement of hot and cold mirrors for increasing phosphor efficiency;

FIG. 24A shows a sample microscope image of a printed textbook;

FIG. 24B shows a sample microscope image of a halftoned newspaper image;

FIG. 25A shows a sample microscope image of a t-shirt textile weave;

FIG. 25B shows a sample microscope image of liquidambar catkin;

FIG. 26 is a process flow diagram for operation of a Netpage Augmented Reality Viewer;

FIG. 27 shows determination of device-world pose;

FIG. 28 is a page ID and page description object model;

FIG. 29 is an example of a projection of a printed graphic element onto a display screen based on device-page pose and user-device pose when the Viewer device is above a page;

FIG. 30 is an example of a projection of a printed graphic element onto a display screen based on device-page pose and user-device pose when the Viewer device is resting on a page; and

FIG. 31 shows projection geometry for projection of a 3D point onto a projection plane.

### DETAILED DESCRIPTION

### 1. Netpage System Overview

### 1.1 Netpage System Architecture

By way of background, the Netpage system employs a printed page having graphic content superimposed with a Netpage coding pattern. The Netpage coding pattern typically takes the form of a coordinate grid comprised of an array of millimetre-scale tags. Each tag encodes the two-dimensional coordinates of its location as well as a unique identifier for the page. When a tag is optically imaged by a Netpage reader (e.g. pen), the pen is able to identify the page identity as well as its own position relative to the page. When the user of the pen moves the pen relative to the coordinate grid, the pen generates a stream of positions. This stream is referred to as digital ink. A digital ink stream also records when the pen makes contact with a surface and when it loses contact with a surface, and each pair of these so-called pen down and pen up events delineates a stroke drawn by the user using the pen.

In some embodiments, active buttons and hyperlinks on each page can be clicked with the sensing device to request information from the network or to signal preferences to a network server. In other embodiments, text written by hand on a page is automatically recognized and converted to computer text in the netpage system, allowing forms to be filled in. In other embodiments, signatures recorded on a netpage are automatically verified, allowing e-commerce transactions to be securely authorized. In other embodiments, text on a netpage may be clicked or gestured to initiate a search based on keywords indicated by the user.

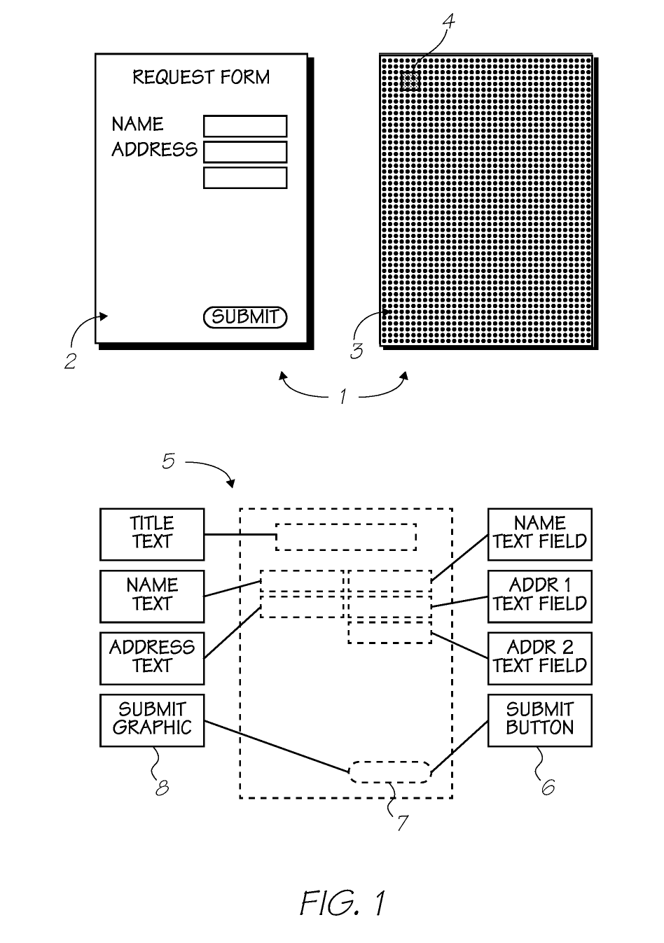

As illustrated in FIG. 1, a printed netpage 1 may represent an interactive form which can be filled in by the user both physically, on the printed page, and “electronically”, via communication between the pen and the netpage system. The example shows a “Request” form containing name and address fields and a submit button. The netpage 1 consists of a graphic impression 2, printed using visible ink, and a surface coding pattern 3 superimposed with the graphic impression. In the conventional Netpage system, the coding pattern 3 is typically printed with an infrared ink and the superimposed graphic impression 2 is printed with colored ink(s) having a complementary infrared window, allowing infrared imaging of the coding pattern 3. The coding pattern 3 is comprised of a plurality of contiguous tags 4 tiled across the surface of the page. Examples of some different tag structures and encoding schemes are described in, for example, US 2008/0193007; US 2008/0193044; US 2009/0078779; US 2010/0084477; US 2010/0084479; Ser. Nos. 12/694,264; 12/694,269; 12/694,271; and 12/694,274, the contents of each of which are incorporated herein by reference.

A corresponding page description 5, stored on the netpage network, describes the individual elements of the netpage. In particular it has an input description describing the type and spatial extent (zone) of each interactive element (i.e. text field or button in the example), to allow the netpage system to correctly interpret input via the netpage. The submit button 6, for example, has a zone 7 which corresponds to the spatial extent of the corresponding graphic 8.

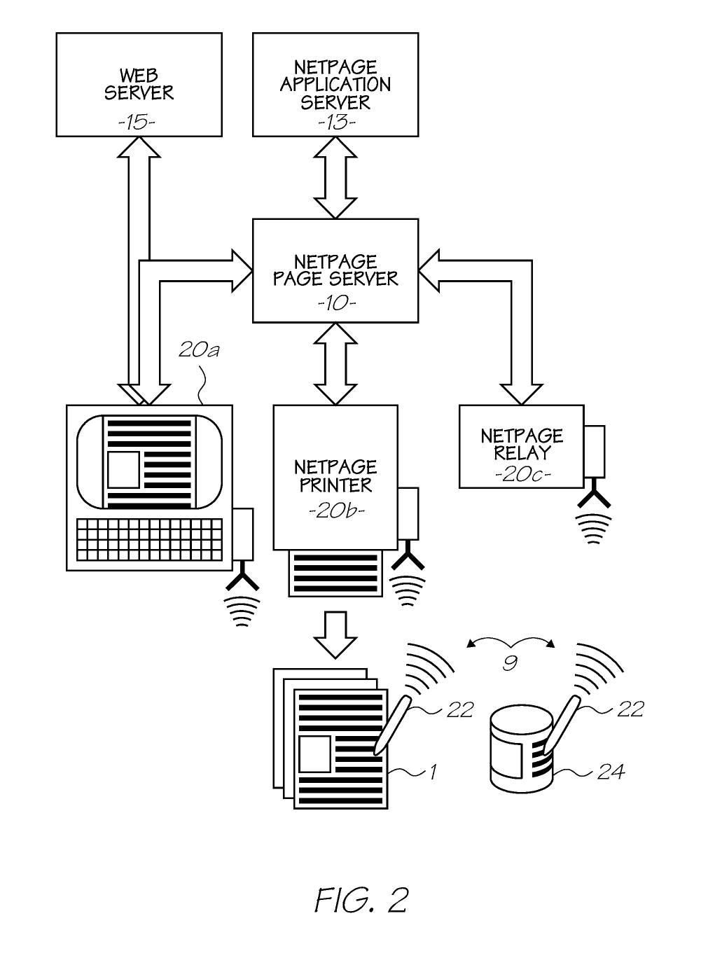

As illustrated in FIG. 2, a netpage reader 22 (e.g. netpage pen) works in conjunction with a netpage relay device 20, which has longer range communications ability. As shown in FIG. 2, the relay device 20 may, for example, take the form of a personal computer 20a communicating with a web server 15, a netpage printer 20b or some other relay 20c (e.g. a PDA, laptop or mobile phone incorporating a web browser). The Netpage reader 22 may be integrated into a mobile phone or PDA so as to eliminate the requirement for a separate relay.

The netpages 1 may be printed digitally and on-demand by the Netpage printer 20b or some other suitably configured printer. Alternatively, the netpages may be printed by traditional analog printing presses, using such techniques as offset lithography, flexography, screen printing, relief printing and rotogravure, as well as by digital printing presses, using techniques such as drop-on-demand inkjet, continuous inkjet, dye transfer, and laser printing.

As shown in FIG. 2, the netpage reader 22 interacts with a portion of the position-coding tag pattern on a printed netpage 1, or other printed substrate such as a label of a product item 24, and communicates, via a short-range radio link 9, the interaction to the relay device 20. The relay 20 sends corresponding interaction data to the relevant netpage page server 10 for interpretation. Raw data received from the netpage reader 22 may be relayed directly to the page server 10 as interaction data. Alternatively, the interaction data may be encoded in the form of an interaction URI and transmitted to the page server 10 via a user's web browser 20c. The web browser 20c may then receive a URI from the page server 10 and access a webpage via a webserver 201. In some circumstances, the page server 10 may access application computer software running on a netpage application server 13.

The netpage relay device 20 can be configured to support any number of readers 22, and a reader can work with any number of netpage relays. In the preferred implementation, each netpage reader 22 has a unique identifier. This allows each user to maintain a distinct profile with respect to a netpage page server 10 or application server 13.

### 1.2 Netpages

Netpages are the foundation on which a netpage network is built. They provide a paper-based user interface to published information and interactive services.

As shown in FIG. 1, a netpage consists of a printed page (or other surface region) invisibly tagged with references to an online description 5 of the page. The online page description 5 is maintained persistently by the netpage page server 10. The page description has a visual description describing the visible layout and content of the page, including text, graphics and images. It also has an input description describing the input elements on the page, including buttons, hyperlinks, and input fields. A netpage allows markings made with a netpage pen on its surface to be simultaneously captured and processed by the netpage system.

Multiple netpages (for example, those printed by analog printing presses) can share the same page description. However, to allow input through otherwise identical pages to be distinguished, each netpage may be assigned a unique page identifier in the form of a page ID (or, more generally, an impression ID). The page ID has sufficient precision to distinguish between a very large number of netpages.

Each reference to the page description 5 is repeatedly encoded in the netpage pattern. Each tag (and/or a collection of contiguous tags) identifies the unique page on which it appears, and thereby indirectly identifies the page description 5. Each tag also identifies its own position on the page, typically via encoded Cartesian coordinates. Characteristics of the tags are described in more detail below and the cross-referenced patents and patent applications above.

Tags are typically printed in infrared-absorptive ink on any substrate which is infrared-reflective, such as ordinary paper, or in infrared fluorescing ink. Near-infrared wavelengths are invisible to the human eye but are easily sensed by a solid-state image sensor with an appropriate filter.

A tag is sensed by a 2D area image sensor in the netpage reader 22, and the interaction data corresponding to decoded tag data is usually transmitted to the netpage system via the nearest netpage relay device 20. The reader 22 is wireless and communicates with the netpage relay device 20 via a short-range radio link. Alternatively, the reader itself may have an integral computer system, which enables interpretation of tag data without reference to a remote computer system, It is important that the reader recognize the page ID and position on every interaction with the page, since the interaction is stateless. Tags are error-correctably encoded to make them partially tolerant to surface damage.

The netpage page server 10 maintains a unique page instance for each unique printed netpage, allowing it to maintain a distinct set of user-supplied values for input fields in the page description 5 for each printed netpage 1.

### 1.3 Netpage Tags

Each tag 4, contained in the position-coding pattern 3, identifies an absolute location of that tag within a region of a substrate.

Each interaction with a netpage should also provide a region identity together with the tag location. In a preferred embodiment, the region to which a tag refers coincides with an entire page, and the region ID is therefore synonymous with the page ID of the page on which the tag appears. In other embodiments, the region to which a tag refers can be an arbitrary subregion of a page or other surface. For example, it can coincide with the zone of an interactive element, in which case the region ID can directly identify the interactive element.

As described in some of the Applicant's previous applications (e.g. U.S. Pat. No. 6,832,717 incorporated herein by reference), the region identity may be encoded discretely in each tag 4. As described other of the Applicant's applications (e.g. U.S. application Ser. Nos. 12/025,746 & 12/025,765 filed on Feb. 5, 2008 and incorporated herein by reference), the region identity may be encoded by a plurality of contiguous tags in such a way that every interaction with the substrate still identifies the region identity, even if a whole tag is not in the field of view of the sensing device.

Each tag 4 should preferably identify an orientation of the tag relative to the substrate on which the tag is printed. Strictly speaking, each tag 4 identifies an orientation of tag data relative to a grid containing the tag data. However, since the grid is typically oriented in alignment with the substrate, then orientation data read from a tag enables the rotation (yaw) of the netpage reader 22 relative to the grid, and thereby the substrate, to be determined.

A tag 4 may also encode one or more flags which relate to the region as a whole or to an individual tag. One or more flag bits may, for example, signal a netpage reader 22 to provide feedback indicative of a function associated with the immediate area of the tag, without the reader having to refer to a corresponding page description 5 for the region. A netpage reader may, for example, illuminate an “active area” LED when positioned in the zone of a hyperlink.

A tag 4 may also encode a digital signature or a fragment thereof. Tags encoding digital signatures (or a part thereof) are useful in applications where it is required to verify a product's authenticity. Such applications are described in, for example, US Publication No. 2007/0108285, the contents of which is herein incorporated by reference. The digital signature may be encoded in such a way that it can be retrieved from every interaction with the substrate. Alternatively, the digital signature may be encoded in such a way that it can be assembled from a random or partial scan of the substrate.

It will, of course, be appreciated that other types of information (e.g. tag size etc) may also be encoded into each tag or a plurality of tags.

For a full description of various types of netpage tags 4, reference is made to some of the Applicant's previous patents and patent applications, such as U.S. Pat. No. 6,789,731; U.S. Pat. No. 7,431,219; U.S. Pat. No. 7,604,182; US 2009/0078778; and US 2010/0084477, the contents of which are herein incorporated by reference.

### 2. Netpage Viewer Overview

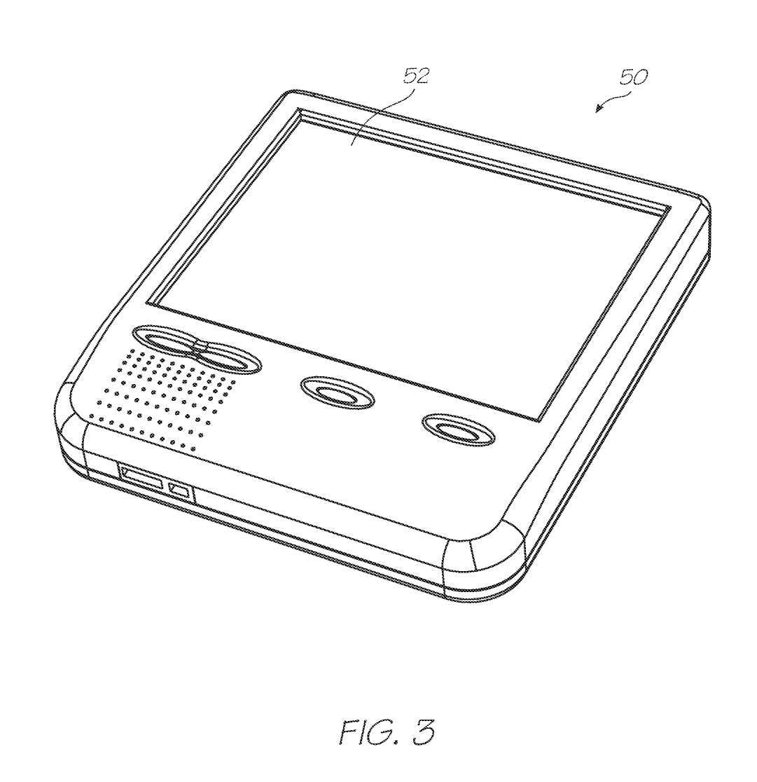

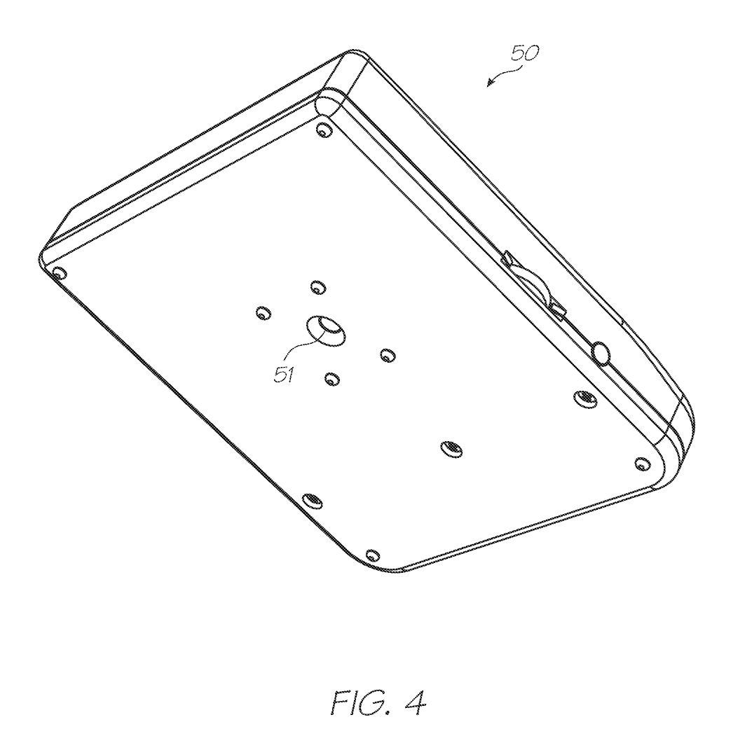

The Netpage Viewer 50, shown in FIGS. 3 and 4, is a type of Netpage reader and is described in detail in the Applicant's U.S. Pat. No. 6,788,293, the contents of which are herein incorporated by reference. The Netpage Viewer 50 has an image sensor 51 positioned on its lower side for sensing Netpage tags 4, and a display screen 52 on its upper side for displaying content to the user.

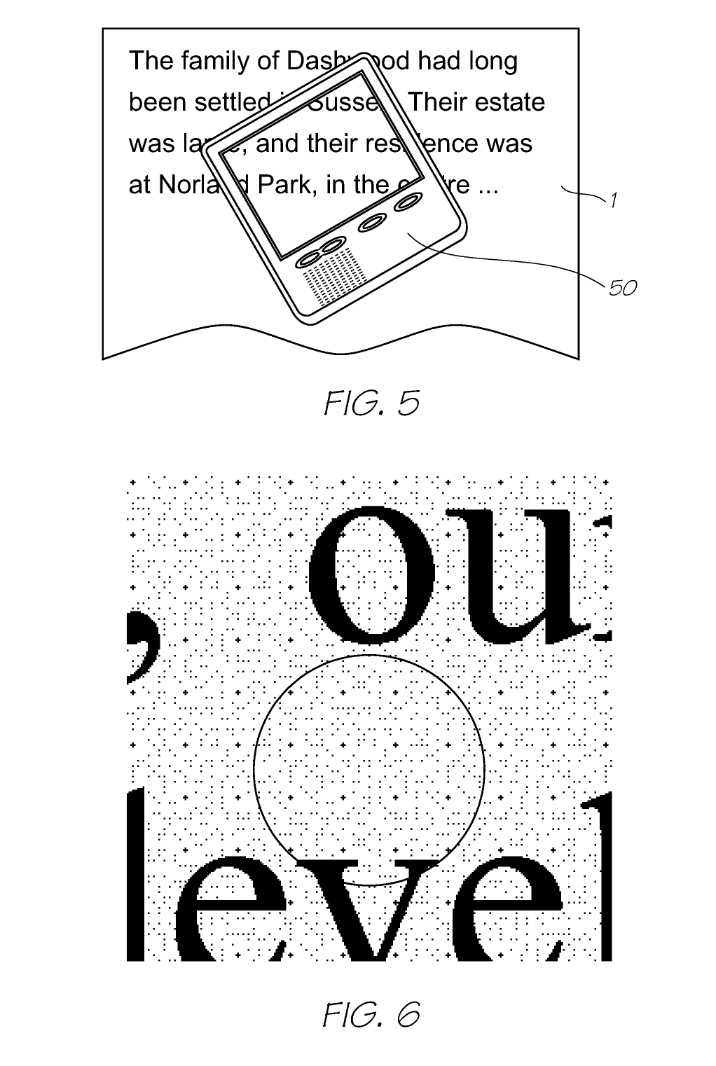

In use, and referring to FIG. 5, the Netpage Viewer device 50 is placed in contact with a printed Netpage 1 having tags (not shown in FIG. 5) tiled over its surface. The image sensor 51 senses one or more of the tags 4, decodes the coded information and transmits this decoded information to the Netpage system via a transceiver (not shown). The Netpage system retrieves a page description corresponding to the page ID encoded in the sensed tag and sends the page description (or corresponding display data) to the Netpage Viewer 50 for display on the screen. Typically, the Netpage 1 has human readable text and/or graphics, and the Netpage Viewer provides the user with the experience of virtual transparency, optionally with additional functionality available via touchscreen interactions with the displayed content (e.g. hyperlinking, magnification, translation, playing video etc).

Since each tag incorporates data identifying the page ID and its own location on the page, the Netpage system can determine the location of the Netpage Viewer 50 relative to the page and so can extract information corresponding to that position. Additionally the tags include information which enables the device to derive its orientation relative to the page. This enables the displayed content to be rotated relative to the device so as to match the orientation of the text. Thus, information displayed by the Netpage Viewer 50 is aligned with content printed on the page, as shown in FIG. 5, irrespective of the orientation of the Viewer.

As the Netpage Viewer device 50 is moved, the image sensor 51 images the same or different tags, which enables the device and/or system to update the device's relative position on the page and to scroll the display as the device moves. The position of the Viewer device relative to the page can easily be determined from the image of a single tag; as the Viewer moves the image of the tag changes, and from this change in image, the position relative to the tag can be determined.

It will be appreciated that the Netpage Viewer 50 provides users with a richer experience of printed substrates. However, the Netpage Viewer typically relies on detection of Netpage tags 4 for identifying a page identity, position and orientation in order to provide the functionality described above and described in more detail in U.S. Pat. No. 6,788,293. Further, in order for the Netpage coding pattern to be invisible (or at least nearly invisible), it is necessary to print the coding pattern with customized invisible IR inks, such as those described by the present Applicant in U.S. Pat. No. 7,148,345. It would be desirable to provide the functionality of Netpage Viewer interactions without the requirement for pages printed with specialized inks or inks which are highly visible to users (e.g. black inks). Moreover, it would be desirable to incorporate Netpage Viewer functionality into conventional smartphones, without the need for a customized Netpage Viewer device.

### 3 Overview of Interactive Paper Schemes

Existing applications for smartphones enable decoding of barcodes and recognition of page content, typically via OCR and/or recognition of page fragments. Page fragment recognition uses a server-side index of rotationally-invariant fragment features, a client- or server-side extraction of features from captured images and a multi-dimensional index lookup. Such applications make use of the smartphone camera without modification of the smartphone. Inevitably, these applications are somewhat brittle due to the poor focusing of the smartphone camera and resultant errors in OCR and page fragment recognition techniques.

### 3.1 Standard Netpage Pattern

As described above, the standard Netpage pattern developed by the present Applicant typically takes the form of a coordinate grid comprised of an array of millimetre-scale tags. Each tag encodes the two-dimensional coordinates of its location as well as a unique identifier for the page. Some key characteristics of the standard Netpage pattern are:

page ID and position from decoded pattern

readable anywhere when co-printed with IR-transparent inks

invisible when printed using IR ink

compatible with most analogue and digital printers & media

compatible with all Netpage readers

The standard Netpage pattern has a high page ID capacity (e.g. 80 bits), which is matched to a high unique page volume of digital printing. Encoding a relatively large amount of data in each tag requires a field of view of about 6 mm in order to capture all the requisite data with each interaction. The standard Netpage pattern additionally requires relatively large target features which enable calculation of a perspective transform, thereby allowing the Netpage pen to determine its pose relative to the surface.

### 3.2 Fine Netpage Pattern

A fine Netpage pattern, described herein in more detail in Section 4, has the key characteristics of:

page ID and position from decoded pattern

readable interstitially between typical lines of 8-point text

invisible when printed using standard yellow ink (or IR ink)

compatible mainly with offset-printed magazine stock

compatible mainly with contact Netpage Viewer

Typically, the fine Netpage pattern has a lower page ID capacity than the standard Netpage pattern, because the page ID may be augmented with other information acquired from the surface so as to identify a particular page. Furthermore, the lower unique page volume of analogue printing does not necessitate an 80-bit page ID capacity. As a consequence, the field of view required to capture data from a tag the fine Netpage pattern is significantly smaller (about 3 mm) Moreover, since the fine Netpage pattern is designed for use with a contact viewer having fixed pose (i.e. an optical axis perpendicular to the surface of the paper), then the fine Netpage pattern does not require features (e.g. relatively large target features) enabling the pose of a Netpage pen to be determined Consequently, the fine Netpage pattern has lower coverage on paper and is less visible than the standard Netpage pattern when printed with visible inks (e.g. yellow).

### 3.3 Hybrid Pattern Decoding and Fragment Recognition

A hybrid pattern decoding and fragment recognition scheme has the key characteristics of:
page ID and position from recognition of page fragment (or sequence of page fragments), augmented by Netpage pattern (fine color or standard IR) when pattern is visible in FOV
index lookup cost is enormously reduced by pattern context

In other words the hybrid scheme provides an unobstrusive Netpage pattern which can be printed in visible (e.g. yellow) ink combined with accurate page identification—in interstitial areas having no text or graphics, the Netpage Viewer can rely on the fine Netpage pattern; in areas containing text or graphics, page fragment recognition techniques are used to identify the page. Significantly, there are no constraints on the ink used to print the fine Netpage pattern. The ink used for the fine Netpage pattern may be opaque when coprinted with text/graphics, provided that it is still visible to the Netpage Viewer in interstitial areas of the page. Therefore, in contrast with other schemes used for page recognition (e.g. Anoto), there is no requirement to print the coding pattern in a highly visible black ink and rely on IR-transparent process black (CMY) for printing text/graphics. The present invention enables the coding pattern to be printed in unobtrusive inks, such as yellow, whilst maintaining excellent page identification.

### 4 Fine Netpage Pattern

The fine Netpage pattern is minimally a scaled-down version of the standard Netpage pattern. Where the standard pattern requires a field of view of 6 mm, the scaled-down (by half) fine pattern requires a field of view of only 3 mm to contain an entire tag. Furthermore, the pattern typically allows error-free pattern acquisition and decoding from the interstitial space between successive lines of typical magazine text. Assuming a larger field of view than 3 mm, a decoder can acquire fragments of the required tag from more distributed fragments if necessary.

The fine pattern can therefore be co-printed with text and other graphics that are opaque at the same wavelengths as the pattern itself

The fine pattern, due to its small feature size (not requiring perspective distortion targets) and low coverage (lower data capacity), can be printed using a visible ink such as yellow.

FIG. 6 shows a 6 mm×6 mm fragment of the fine Netpage pattern at 20× scale, co-printed with 8-point text, and showing the size of the nominal minimum 3 mm field of view.

### 5 Page Fragment Recognition

### 5.1 Overview

The purpose of the page fragment recognition technique is to enable a device to identify a page, and a position within that page, by recognising one or more images of small fragments of the page. The one or more fragment images are captured successively within the field of view of a camera in close proximity to the surface (e.g. a camera having an object distance of 3 to 10 mm) The field of view therefore has a typical diameter between 5 mm and 10 mm. The camera is typically incorporated in a device such as a Netpage Viewer.

Devices such as the Netpage Viewer, whose camera pose is fixed and normal to the surface, capture images that are highly amenable to recognition since they have a consistent scale, no perspective distortion, and consistent illumination.

Printed pages contain a diversity of content including text of various sizes, line art, and images. All may be printed in monochrome or color, typically using C, M, Y and K process inks.

The camera may be configured to capture a mono-spectral image or a multi-spectral image, using a combination of light sources and filters, to extract maximum information from multiple printing inks.

It is useful to apply different recognition techniques to different kinds of page content. In the present technique we apply optical character recognition to text fragments, and general-purpose feature recognition to non-text fragments. This is discussed in detail below.

### 5.2 Text Fragment Recognition

As shown in FIG. 7, a useful number of text glyphs are visible within a modest field of view. The field of view in the illustration has a size of 6 mm×8 mm. The text is set using 8-point Times New Roman, which is typical of magazines, and is shown at 6× scale for clarity.

With this font size, typeface and field-of-view size there are typically an average of 8 glyphs visible within the field of view. A larger field of view will contain more glyphs, or a similar number of glyphs with a larger font size.

With this font size and typeface there are approximately 7000 glyphs on a typical A4/Letter magazine page.

Let us define an (n, m) glyph group key as representing an actual occurrence on a page of text of a (possibly skewed) array of glyphs n rows high and m glyphs wide. Let the key consist of n×m glyph identifiers, and n-1 row offsets. Let row offset i represent the offset between the glyphs of row i and the glyphs of row i-1. A negative offset indicates the number of glyphs in row i whose bounding boxes lie wholly to the left of the first glyph of row i-1. A positive offset indicates the number of glyphs whose bounding boxes lie wholly to the right of the first glyph of row i-1. An offset of zero indicates that the first glyphs of the two rows overlap.

It is possible to systematically construct every possible glyph group key of a certain size for a particular page of text, and record, for each key, the one or more locations where the corresponding glyph group occurs on the page. Furthermore, it is possible, within a sufficiently large field of view placed and oriented at random on that page, to recognise an array of glyphs, construct a corresponding glyph group key, and determine, with reference to the full set of glyph group keys for the page and their corresponding locations, a set of possible locations for the field of view on the page.

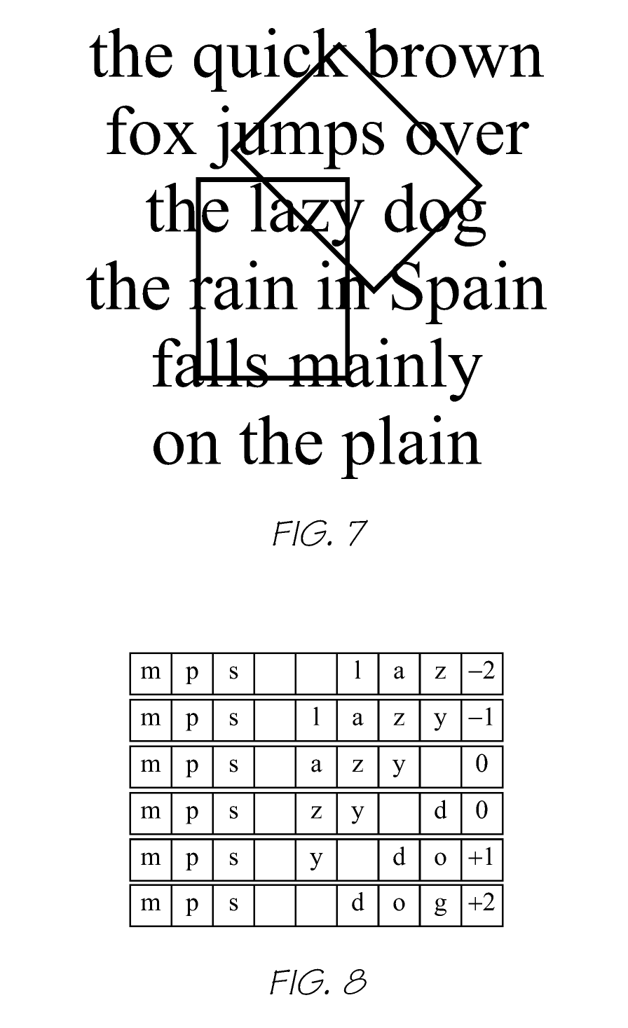

FIG. 8 shows a small number of (2, 4) glyph group keys corresponding to locations in the vicinity of the rotated field of view in FIG. 7, i.e. the field of view that partially overlaps the text “jumps over” and “lazy dog”.

As can be seen in FIG. 7, the key “mps zy d0” is readily constructed from the content of the field of view.

Recognition of individual glyphs relies on well-known optical character recognition (OCR) techniques. Intrinsic to the OCR process is the recognition of glyph rotation, and hence identification of the line direction. This is required to correctly construct a glyph group key.

If the page is already known then the key can be matched with the known keys for the page to determine one or more possible locations of the field of view on the page. If the key has a unique location then the location of the field of view is thereby known. Almost all (2, 4) keys are unique within a page.

If the page is not yet known, then a single key will generally not be sufficient to identify the page. In this case the device containing the camera can be moved across the page to capture additional page fragments. Each successive fragment yields a new key, and each key yields a new set of candidate pages. The candidate set of pages consistent with the full set of keys is the intersection of the set of pages associated with each key. As the set of keys grows the candidate set shrinks, and the device can signal the user when a unique page (and location) is identified.

This technique obviously also applies when a key is not unique within a page.

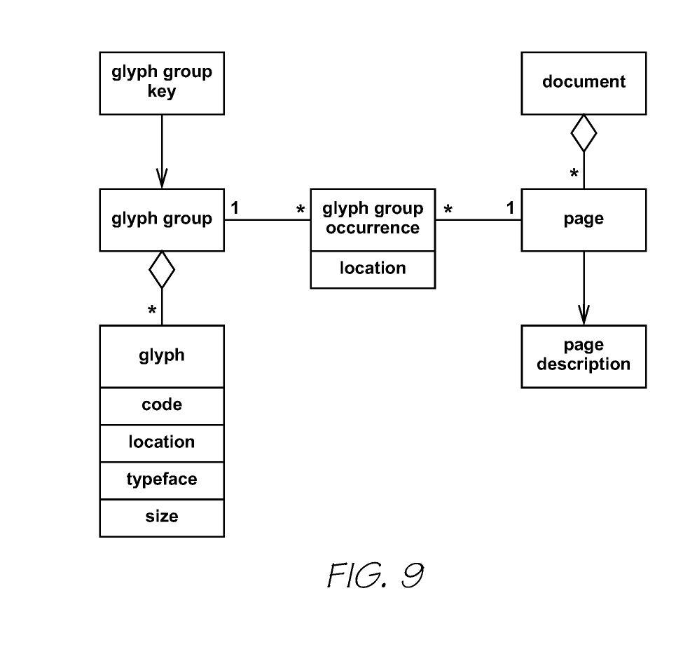

FIG. 9 shows an object model for the glyph groups occurring on the pages of a set of documents.

Each glyph group is identified by a unique glyph group key, as previously described. A glyph group may occur on any number of pages, and a page contains a number of glyph groups proportional to the number of glyphs on the page.

Each occurrence of a glyph group on a page identifies the glyph group, the page, and the spatial location of the glyph group on the page.

A glyph group consists of a set of glyphs, each with an identifying code (e.g. a Unicode code), a spatial location within the group, a typeface and a size.

A document consists of a set of pages, and each page has a page description that describes both the graphical and the interactive content of the page.

The glyph group occurrence can be represented by an inverted index that identifies the set of pages associated with a given glyph group, i.e. as identified by a glyph group key.

Although typeface can be used to help distinguish glyphs with the same code, the OCR technique is not required to identify the typeface of a glyph. Likewise, glyph size is useful but not crucial, and is likely to be quantised to ensure robust matching.

If the device is capable of sensing motion, then the displacement vector between successively captured page fragments can be used to disqualify false candidates. Consider the case of two keys associated with two page fragments. Each key will be associated with one or more locations on each candidate page. Each pairing of such locations within a page will have an associated displacement vector. If none of the possible displacement vectors associated with a page is consistent with the measured displacement vector then that page can be disqualified.

Note that the means for sensing motion can be quite crude and still be highly useful. For example, even if the means for sensing motion only yields a highly quantised displacement direction, this can be enough to usefully disqualify pages.

The means for sensing motion may employ various techniques e.g. using optical mouse techniques whereby successively captured overlapping images are correlated; by detecting the motion blur vector in captured images; using gyroscope signals; by doubly integrating the signals from two accelerometers mounted orthogonally in the plane of motion; or by decoding a coordinate grid pattern.

Once a small number of candidate pages have been identified additional image content can be used to determine a true match. For example, the actual fine alignment between successive lines of glyphs is more unique than the quantised alignment encoded in the glyph group key, so can be used to further qualify candidates.

Contextual information can be used to narrow the candidate set to produce a smaller speculative candidate set, to allow it to be subjected to more fine-grained matching techniques. Such contextual information can include the following:

the immediate page and publication that the user has been interacting with

recent publications that the user has interacted with

publications known to the user (e.g. known subscriptions)

recent publications

publications published in the user's preferred language

### 5.3 Image Fragment Recognition

A similar approach and similar set of considerations apply to recognising non-textual image fragments rather than text fragments. However, rather than relying on OCR, image fragment recognition relies on more general-purpose techniques to identify features in image fragments in a rotation-invariant manner and match those features to a previously-created index of features.

The most common approach is to use SIFT (Scale-Invariant Feature Transform; see U.S. Pat. No. 6,711,293, the contents of which are herein incorporated by reference), or a variant thereof, to extract both scale- and rotation-invariant features from an image.

As noted earlier, the problem of image fragment recognition is made considerably easier by a lack of scale variation and perspective distortion when employing the Netpage Viewer.

Unlike the text-oriented approach of the previous section which allowed exact index lookup and scales very well, general feature matching only scales by using approximate techniques, with a concomitant loss of accuracy. As discussed in the previous section, we can achieve accuracy by combining the results of multiple queries, resulting from image acquisition at multiple points on a page, and from the use of motion data.

### 6 Hybrid Netpage Pattern Decoding and Fragment Recognition

Page fragment recognition will not always be reliable or efficient. Text fragment recognition only works where there is text present. Image fragment recognition only works where there is page content (text or graphics). Neither allows recognition of blank areas or solid color areas on a page.

A hybrid approach can be used that relies on decoding the Netpage pattern in blank areas (e.g. interstitial areas between lines of text) and possibly solid-color areas. The Netpage pattern can be a standard Netpage pattern or, preferably, a fine Netpage pattern, and can be printed using an IR ink or a colored ink. To minimise visual impact the standard pattern should be printed using IR, and the fine pattern should be printed using yellow or IR. In neither case is it necessary to use an IR-transparent black. Instead the Netpage pattern can be excluded entirely from non-blank areas.

If the Netpage pattern is first used to identify the page, then this of course provides an immediately narrower context for recognising page fragments.

### 7 Barcode and Document Recognition

Standard recognition of barcodes (linear or 2D) and page content via a smartphone camera can be used to identify a printed page.

This can provide a narrower context for subsequent page fragment recognition, as described in previous sections.

It can also allow a Netpage Viewer to identify and load a page image and allow on-screen interaction without further surface interaction.

### 8 Smartphone Microscope Accessory

### 8.1 Overview

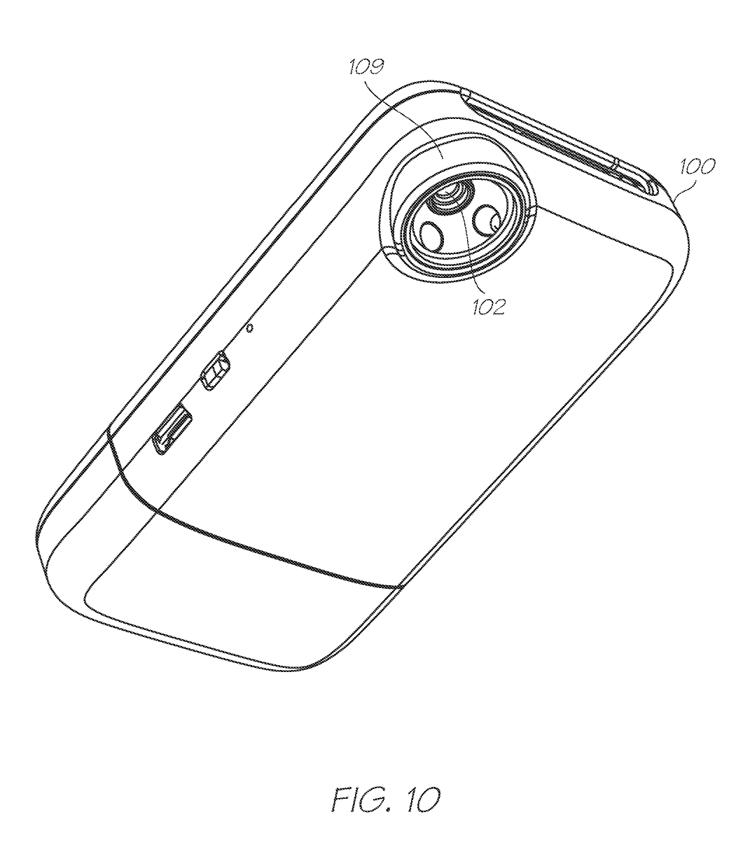

FIG. 10 shows a smartphone assembly comprising a smartphone with a microscope accessory 100 having an additional lens 102 placed in front of the phone's in-built digital camera so as to transform the smartphone into a microscope.

The camera of a smartphone typically faces away from the user when the user is viewing the screen, so that the screen can be used as a digital viewfinder for the camera. This makes a smartphone an ideal basis for a microscope. When the smartphone is resting on a surface with the screen facing the user, the camera is conveniently facing the surface.

It is then possible to view objects and surfaces in close-up using the smartphone's camera preview function; record close-up video; snap close-up photos; and digitally zoom in for an even closer view. Accordingly, with the microscope accessory, a conventional smartphone may be used as a Netpage Viewer when placed in contact with a surface of a page having a Netpage coding pattern or fine Netpage coding pattern printed thereon. Further, the smartphone may be suitably configured for decoding the Netpage pattern or fine Netpage pattern, fragment recognition as described in Sections 5.1-5.3 and/or hybrid techniques as described in Section 6.

It is advantageous to provide one or more sources of illumination to ensure close-up objects and surfaces are well lit. These may include coloured, white, ultraviolet (UV), and infrared (IR) sources, including multiple sources under independent software control. The illumination sources may consist of light-emitting surfaces, LEDs or other lamps.

The image sensor in a smartphone digital camera typically has an RGB Bayer mosaic color filter that allows it to capture color images. The individual red (R), green (G) and blue (B) colour filters may be transparent to ultraviolet (UV) and/or infrared (IR) light, and so in the presence of just UV or IR light the image sensor may be able to act as a UV or IR monochrome image sensor.

By varying the illumination spectrum it becomes possible to explore the spectral reflectivity of objects and surfaces. This can be advantageous when engaged in forensic investigations, e.g. to detect the presence of inks from different ballpoint pens on a document.

As shown in FIG. 10, the microscope lens 102 is provided as part of an accessory 100 designed to attach to a smartphone. For illustrative purposes the smartphone accessory 100 shown in FIG. 10 is designed to attach to an Apple iPhone.

Although illustrated in the form of an accessory, the microscope function may also be fully integrated into a smartphone using the same approach.

### 8.2 Optical Design

The microscope accessory 100 is designed to allow the smartphone's digital camera to focus on and image a surface on which the accessory is resting. For this purpose the accessory contains a lens 102 that is matched to the optics of the smartphone so that the surface is in focus within the auto-focus range of the smartphone camera. Furthermore, the standoff of the optics from the surface is fixed so that auto-focus is achievable across the full wavelength range of interest, i.e. about 300 nm to 900 nm.

If auto-focus is not available then a fixed-focus design may be used. This may involve a trade-off between the supported wavelength range and the required image sharpness.

For illustrative purposes the optical design is matched to the camera in the iPhone 3GS. However, the design readily generalises to other smartphone cameras.

The camera in an iPhone 3GS has a focal length of 3.85 mm, a speed of f/2.8, and a 3.6 mm by 2.7 mm color image sensor. The image sensor has a QXGA resolution of 2048 by 1536 pixels @ 1.75 microns. The camera has an auto-focus range from about 6.5 mm to infinity, and relies on image sharpness to determine focus.

Assuming the desired microscope field of view is at least 6 mm wide, the desired magnification is 0.45 or less. This can be achieved with a 9 mm focal-length lens. Smaller fields of view and larger magnifications can be achieved with shorter focal-length lenses.

Although the optical design has a magnification of less than one, the overall system can reasonably be classed as a microscope because it significantly magnifies surface detail to the user, particularly in conjunction with on-screen digital zoom. Assuming a field of view width of 6 mm and a screen width of 50 mm the magnification experienced by the user is just over 8×.

With a 9 mm lens in place the auto-focus range of the camera is just over 1 mm. This is larger than the focus error experienced over the wavelength range of interest, so setting the standoff of the microscope from the surface so that the surface is in focus at 600 nm in the middle of the auto-focus range ensures auto-focus across the full wavelength range. This is achieved with a standoff of just over 8 mm.

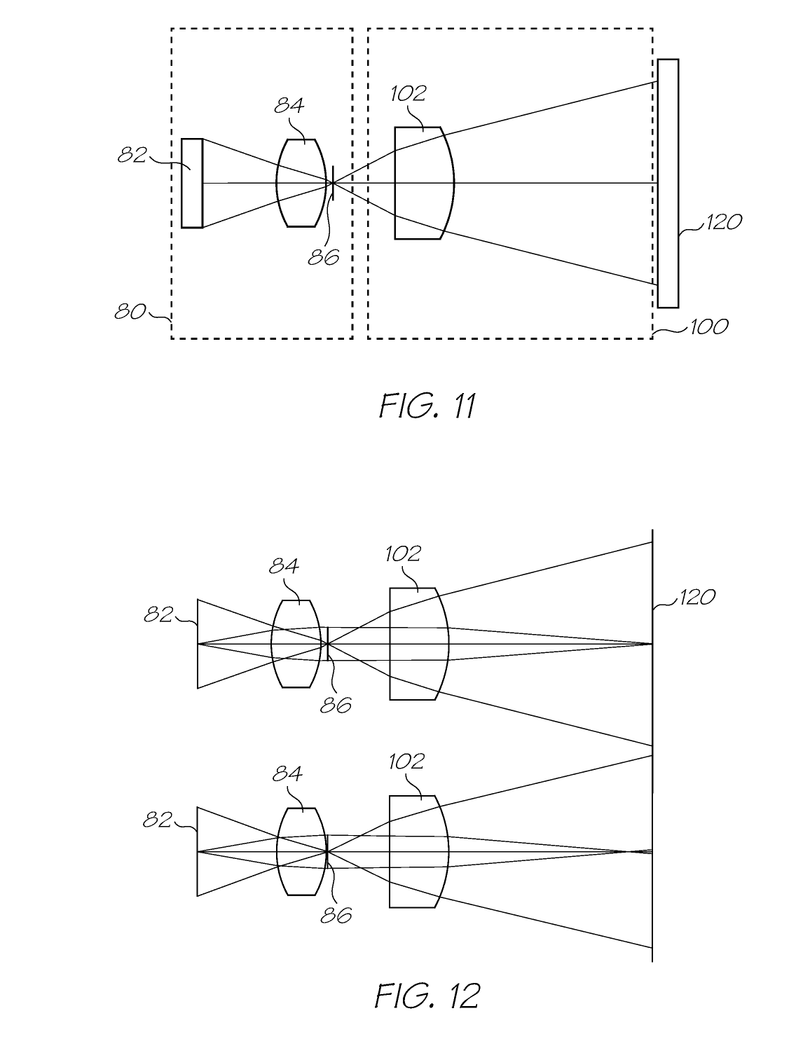

FIG. 11 shows a schematic of the optical design including the iPhone camera 80 on the left, the microscope accessory 100 on the right, and the surface 120 on the far right.

The internal design of the iPhone camera, comprising an image sensor 82, (movable) camera lens 84 and aperture 86, is intended for illustrative purposes. The design matches the nominal parameters of the iPhone camera, but the actual iPhone camera may incorporate more sophisticated optics to minimise aberrations etc. The illustrative design also ignores the camera cover glass.

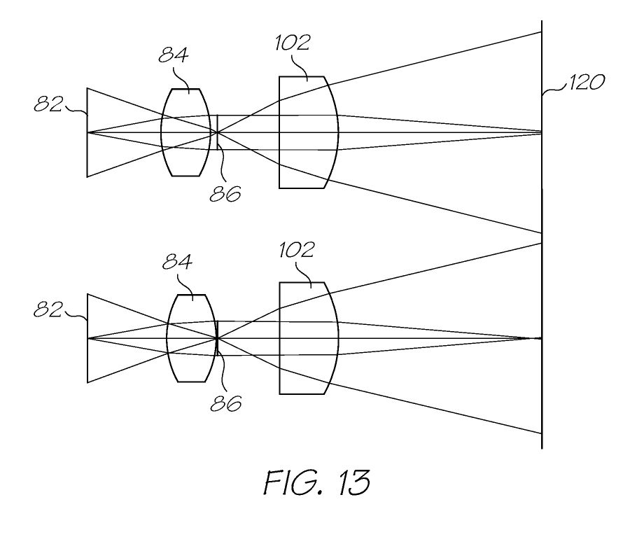

FIG. 12 shows ray traces through the combined optical system at 400 nm, with the camera auto-focus at its two extremes (i.e. focus at infinity and macro focus). FIG. 13 show ray traces through the combined optical system at 800 nm, with the camera auto-focus at its two extremes (i.e. focus at infinity and macro focus). In both cases it can be seen that the surface 120 is in sharp focus somewhere within the focus range.

Note that the illustrative optical design favours focus at the centre of the field of view. Taking into account field curvature may favour a compromise focus position.

The optical design for the microscope accessory 100 illustrated here can benefit from further optimization to reduce aberrations, distortion, and reduce field curvature. Fixed distortion can also be corrected by software before images are presented to the user.

The illumination design can also be improved to ensure more uniform illumination across the field of view. Fixed illumination variations can also be characterised and corrected by software before images are presented to the user.

### 8.3 Mechanical and Electronic Design

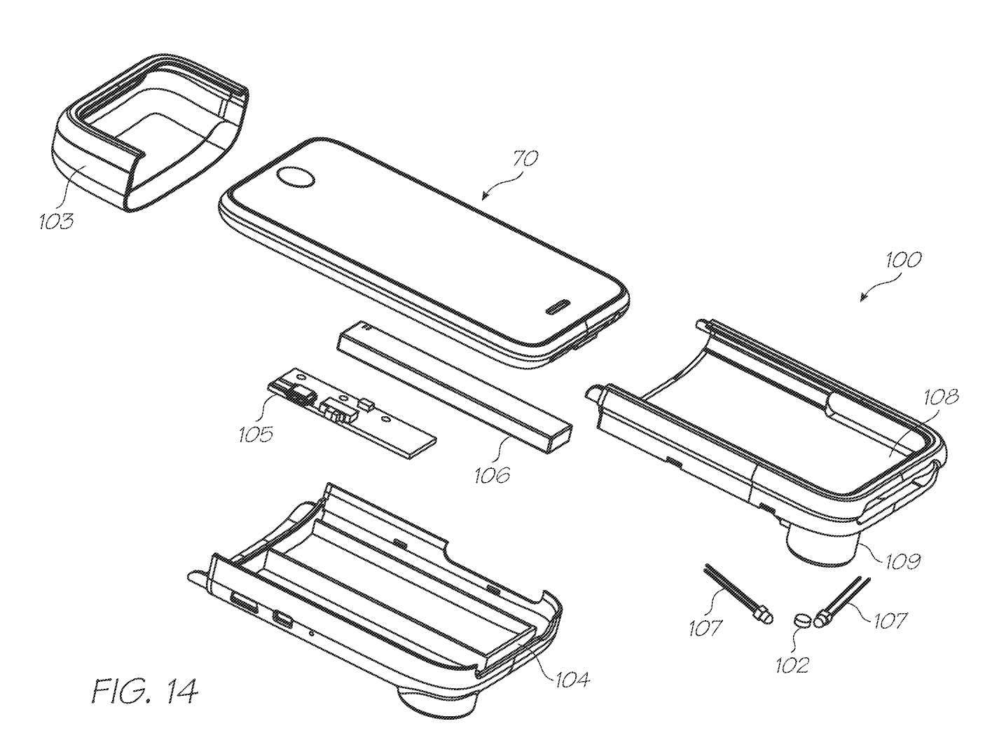

As shown in FIG. 14, the accessory 100 comprises a sleeve that slides onto the iPhone 70 and an end-cap 103 that mates with the sleeve to encapsulate the iPhone. The end-cap 103 and sleeve are designed to be removable from the iPhone 70, but contain apertures that allow the buttons and ports on the iPhone to be accessed without removal of the accessory.

The sleeve consists of a lower moulding 104 that contains a PCB 105 and battery 106, and an upper moulding 108 that contains the microscope lens 102 and LEDs 107. The upper and lower sleeve mouldings 104 and 108 snap together to define the sleeve and seal in the battery 106 and PCB 105. They may also be glued together.

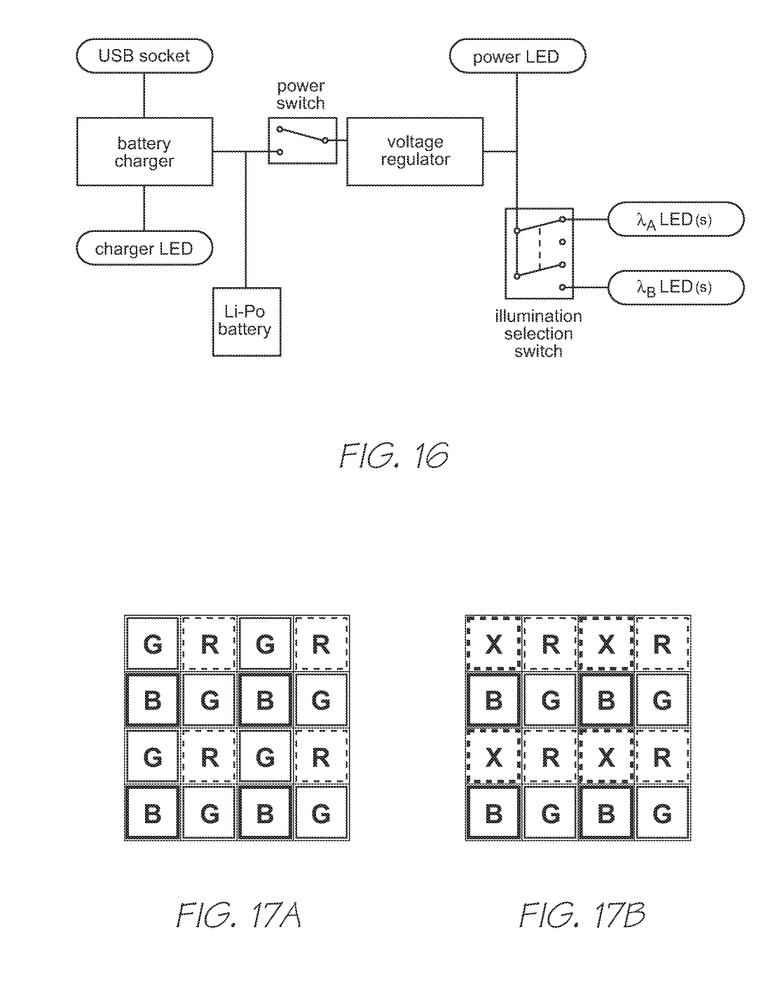

The PCB 105 holds a power switch, charger circuit and USB socket for charging the battery 106. The LEDs 107 are powered from the battery via a voltage regulator. FIG. 16 shows a block diagram of the circuit. The circuit optionally includes a switch for selecting between two or more sets of LEDs 107 with different spectra.

The LEDs 107 and lens 102 are snap fitted into their respective apertures. They may also be glued.

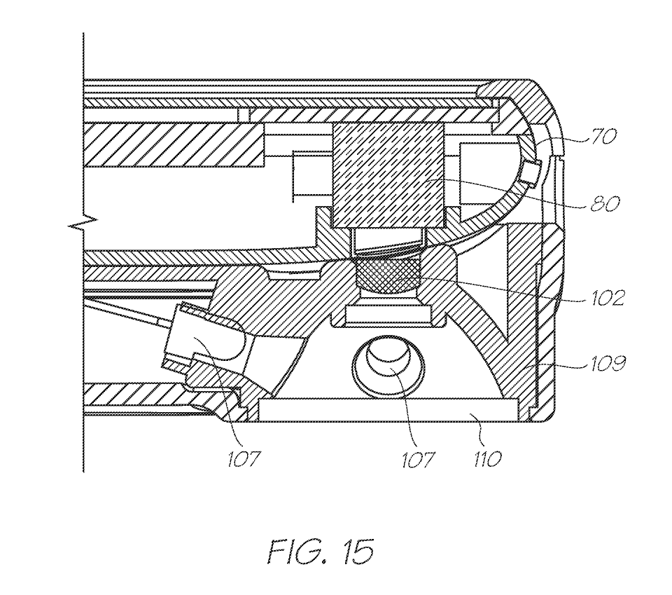

As shown in the cross-sectional view in FIG. 15, the accessory sleeve upper moulding 108 fits flush against the iPhone body to ensure consistent focus.

The LEDs 107 are angled to ensure proper illumination of the surface within the camera field of view. The field of view is enclosed by a shroud 109 having a protective cover 110 to prevent the incursion of ambient light. Inner surfaces of the shroud 109 are optionally provided with a reflective finish to reflect the LED illumination onto the surface.

### 9 Microscope Variations

### 9.1 Microscope Hardware

As outlined in the Section 8, the microscope can be designed as an accessory for a smartphone such as an iPhone without requiring any electrical connection between the accessory and the smartphone. However, it can be advantageous to provide an electrical connection between the accessory and the smartphone for a number of purposes:

to allow the smartphone and accessory to share power (in either direction)

to allow the smartphone to control the accessory

to allow the accessory to notify the smartphone of events detected by the accessory

The smartphone may provide an accessory interface that supports one or more of the following:

DC power source

parallel interface

low-speed serial interface (e.g. UART)

high-speed serial interface (e.g. USB)

The iPhone, for example, provides DC power and a low-speed serial communication interface on its accessory interface.

In addition, a smartphone provides a DC power interface for charging the smartphone battery.

When the smartphone provides DC power on its accessory interface, the microscope accessory can be designed to draw power from the smartphone rather than from its own battery. This can eliminate the need for a battery and charging circuit in the accessory.

Conversely, when the accessory incorporates a battery, this may be used as an auxiliary battery for the smartphone. In this case, when the accessory is attached to the smartphone, the accessory can be configured to supply power to the smartphone when the smartphone needs power, either from the accessory's battery or from the accessory's external DC power source, if present (e.g. via USB).

When the smartphone accessory interface includes a parallel interface it is possible for smartphone software to control individual hardware functions in the accessory. For example, to minimise power consumption the smartphone software can toggle one or more illumination enable pins to enable and disable illumination sources in the accessory in synchrony with the exposure period of the smartphone's camera.

When the smartphone accessory interface includes a serial interface the accessory can incorporate a microprocessor to allow the accessory to receive control commands and report events and status over the serial interface. The microprocessor can be programmed to control the accessory hardware in response to control commands, such as enabling and disabling illumination sources, and report hardware events such as the activation of a buttons and switches incorporated in the accessory.

### 9.2 Microscope Software

Minimally the smartphone provides a user interface to the microscope by providing a standard user interface to the in-built camera. A standard smartphone camera application typically supports the following functions:

real-time video display

still image capture

video recording

spot exposure control

spot focus

digital zoom

Spot exposure and focus control, as well as digital zoom, may be provided directly via the touchscreen of the smartphone.

A microscope application running on the smartphone can provide these standard functions while also controlling the microscope hardware. In particular, the microscope application can detect the proximity of a surface and automatically enable the microscope hardware, including automatically selecting the microscope lens and enabling one or more illumination sources. It can continue to monitor surface proximity while it is running, and enable or disable microscope mode as appropriate. If, once the microscope lens is in place, the application fails to capture sharp images, then it can be configured to disable microscope mode.

Surface proximity can be detected using a variety of techniques, including via a microswitch configured to be activated via a surface-contacting button when the microscope-enabled smartphone is placed on a surface; via a range finder; via the detection of excessive blur in the camera image in the absence of the microscope lens; and via the detection of a characteristic contact impulse using the smartphone's accelerometer.

Automatic microscope lens selection is discussed in Section 9.4.

The microscope application can also be configured to be launched automatically when the microscope hardware detects surface proximity. In addition, if microscope lens selection is manual, the microscope application can be configured to be launched automatically when the user manually selects the microscope lens.

The microscope application can provide the user with manual control over enabling and disabling the microscope, e.g. via on-screen buttons or menu items. When the microscope is disabled the application can act as a typical camera application.

The microscope can provide the user with control over the illumination spectrum used to capture images. The user can either select a particular illumination source (white, UV, IR etc.), or specify the interleaving of multiple sources over successive frames to capture composite multi-spectral images.

The microscope application can provide additional user-controlled functions, such as a calibrated ruler display.

### 9.3 Spectral Imaging

Enclosing the field of view to prevent the incursion of ambient light is only necessary if the illumination spectrum and the ambient light spectrum are significantly different, for example if the illumination source is infrared rather than white. Even then, if the illumination source is significantly brighter than the ambient light then the illumination source will dominate.

A filter with a transmission spectrum matched to the spectrum of the illumination source may be placed in the optical path as an alternative to enclosing the field of view.

FIG. 17A shows a conventional Bayer color filter mosaic on an image sensor, which has pixel-level colour filters with an R:G:B coverage ratio of 1:2:1. FIG. 17B shows a modified color filter mosaic, which includes pixel-level filters for a different spectral component (X), with an X:R:G:B coverage ratio of 1:1:1:1. The additional spectral component might, for example, be a UV or IR spectral component, with the corresponding filter having a transmission peak in the centre of the spectral component and low or zero transmission elsewhere.

The image sensor then becomes innately sensitive to this additional spectral component, limited, of course, by the fundamental spectral sensitivity of the image sensor, which drops off rapidly in the UV part of the spectrum, and above 1000 nm in the near-IR part of the spectrum.

Sensitivity to additional spectral components can be introduced using additional filters, either by interleaving them with the existing filters in an arrangement where each spectral component is represented more sparsely, or by replacing one or more of the R, G and B filter arrays.

Just as the individual colour planes in a traditional RGB Bayer mosaic colour image can be interpolated to produce a colour image with an RGB value for each pixel, so a XRGB mosaic colour image can be interpolated to produce a colour image with an XRGB value for each pixel, and so on for other spectral components, if present.

As noted in the previous section, composite multi-spectral images can also be generated by combining successive images of the same surface captured with different illumination sources enabled. In this case it is advantageous to lock the auto-focus mechanism after acquiring focus at a wavelength near the middle of the overall composite spectrum, so that successive images remain in proper registration.

### 10.4 Microscope Lens Selection

The microscope lens, when in place, prevents the internal camera of the smartphone from being used as a normal camera. It is therefore advantageous for the microscope lens to be in place only when the user requires macro mode. This can be supported using a manual mechanism or an automatic mechanism.

To support manual selection the lens can be mounted so as to allow the user to slide or rotate it into place in front of the internal camera when required.

FIGS. 18A and 18B show the microscope lens 102 mounted in a slidable tongue 112. The tongue 112 is slidably engaged with recessed tracks 114 in the sleeve upper moulding 108, allowing the user to slide the tongue laterally into position in front of the camera 80 inside the shroud 109. The slidable tongue 112 includes a set of raised ridges defining a grip portion 115 that facilitates manual engagement with the tongue during sliding.

To support automatic selection, the slidable tongue 115 can be coupled to an electric motor, e.g. via a worm gear mounted on a motor axle and coupled to matching teeth moulded or set into the edge of one of the tracks 114.

Motor speed and direction can be controlled via a discrete or integrated motor control circuit. End-limit detection can be implemented explicitly using e.g. limit switches or direct motor sensing, or implicitly using e.g. a calibrated stepper motor.

The motor can be activated via a user-operated button or switch, or can be operated under software control, as discussed further below.

### 9.5 Folded Optics

The direct optical path illustrated in FIG. 11 has the advantage that it is simple, but the disadvantage that it imposes a standoff from the surface 120 which is proportional to the size of the desired field of view.

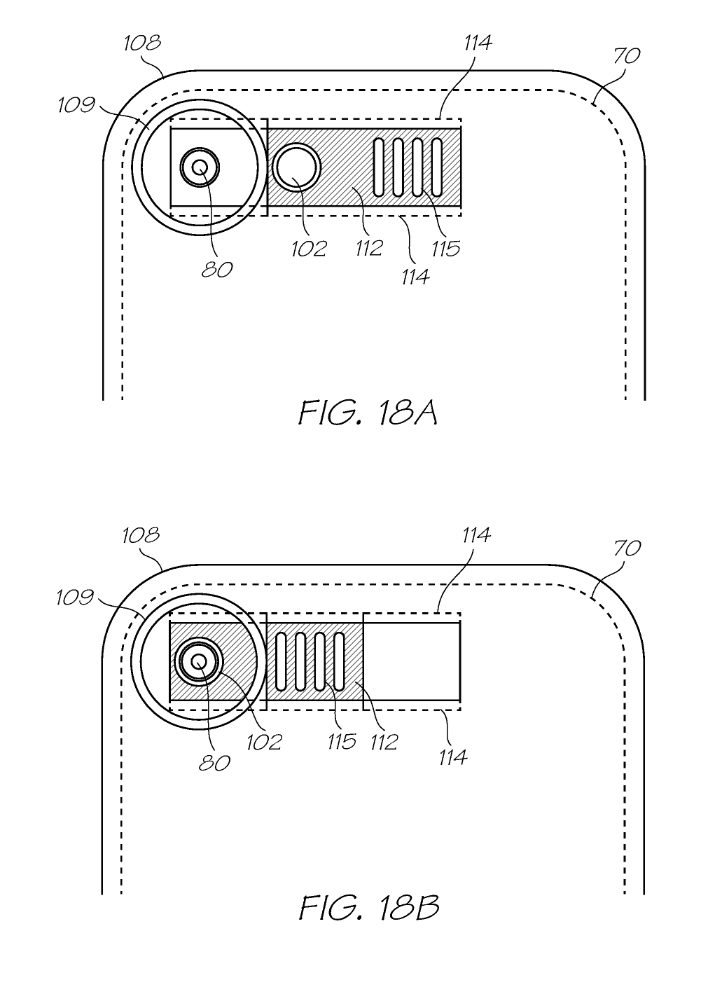

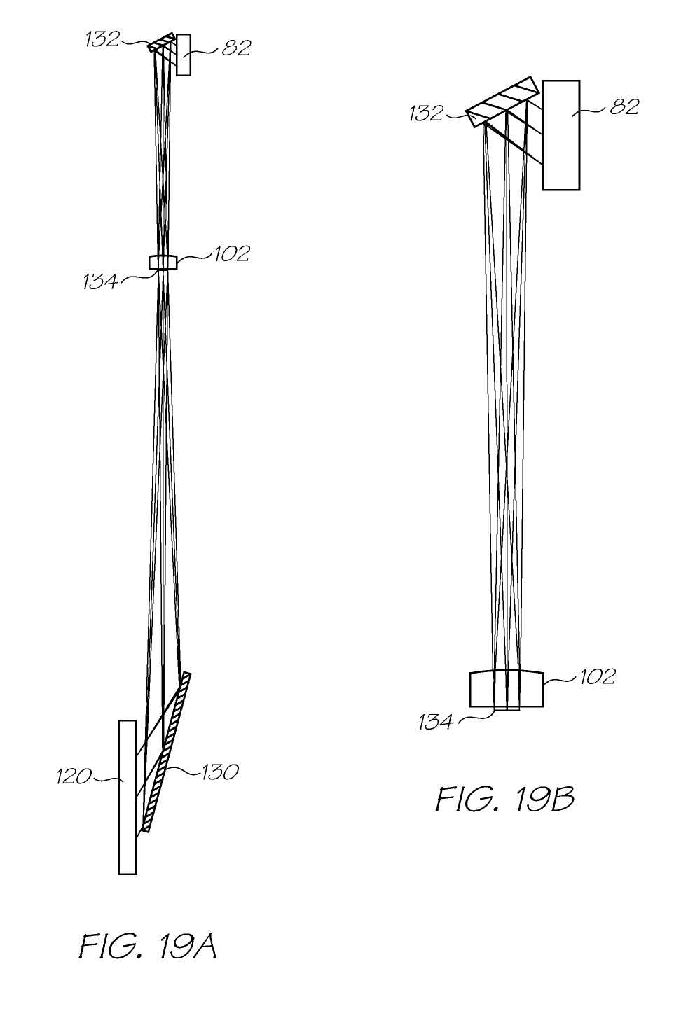

To minimise the standoff it is possible to use a folded optical path, as illustrated in FIG. 19A and FIG. 19B. The folded path utilises a first large mirror 130 to deflect the optical path parallel to the surface 120, and a second small mirror 132 to deflect the optical path to the image sensor 82 of the camera.

The standoff is then a function of the size of the desired field of view and the acceptable tilt of the large mirror 130, which introduces perspective distortion.

This design is may be used either to augment an existing camera in a smartphone, or it may be used as alternative design for a built-in camera on a smartphone.

The design assumes a field of view of 6 mm, a magnification of 0.25, and an object distance of 40 mm. The focal length of the lens is 12 mm and the image distance is 17 mm.

Because of the foreshortening associated with the tilt of mirrors the required optical magnification is closer to 0.4 to achieve an effective magnification of 0.25. The net foreshortening effect introduced by the two mirrors, if tilted at θ and φ respectively, is given by:

$$\frac{cos ( \frac{π}{2} - 2 θ )}{cos ( \frac{ π}{2} - 2 φ )}$$

Since the foreshortening is fixed by the optical design it can be systematically corrected by software before images are presented to the user.

Although foreshortening can be eliminated by matching the tilts of the two mirrors, this leads to poor focus. In the design the large mirror is tilted at 15 degrees to the surface to minimise the standoff. The second mirror is tilted at 28 degrees to the optical axis to ensure the entire field of view is in focus. The ray traces in FIG. 19A and FIG. 19B show good focus.

The perpendicular distance from image plane to the object plane in this design is 3 mm, i.e. 2 mm from the surface to the centre of the large mirror, and 1 mm from the centre of the small mirror to the image sensor. The design is therefore amenable to being incorporated into a smartphone body or into a very slim smartphone accessory.

If the image sensor 82 is required to do double duty as part of the microscope and as part of the smartphone's general-purpose camera 80, then the small mirror 132 can be configured to swivel into place as shown in FIG. 19B when microscope mode is required, and swivel to a position normal to the image sensor 82 when general-purpose camera mode is required (not shown).

Swivelling can be effected by mounting the small mirror 132 on a shaft that is coupled to an electric motor under software control.

9.6 Folded Optics in Conjunction with Smartphone Camera

It is also possible to implement a folded optical path in conjunction with the in-built camera in a smartphone.

FIG. 20 shows an integrated folded optical component 140 placed relative to the in-built camera 80 of an iPhone 4. The folded optical component 140 incorporates the three required elements in a single component, i.e. the microscope lens 102 and the two mirrored surfaces. As before, it is designed to deliver the requisite object distance while minimising the standoff by implementing part of the optical path parallel to the surface 120. It is designed to be housed in an accessory (not shown) that attaches to an iPhone 4 in this case. The accessory may be designed to allow the lens to be manually or automatically moved into place in front of the camera when required, and moved out of the way when not required.

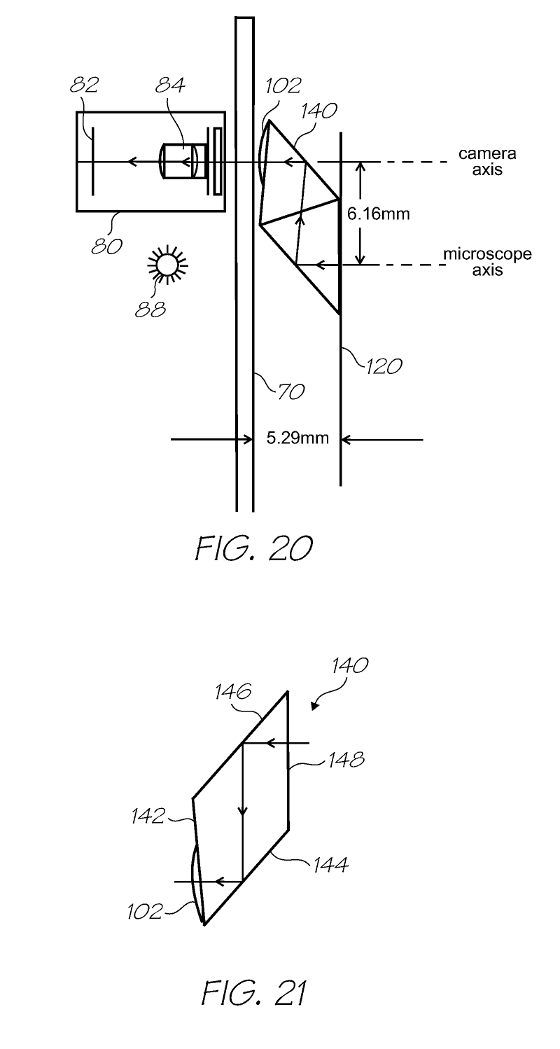

FIG. 21 shows the folded optical component 140 in more detail. Its first (transmitting) surface 142, immediately adjacent to the camera, is curved to provide the requisite focal length. Its second (reflecting) surface 144 reflects the optical path close to parallel to the surface 120. Its third (half-reflecting) surface 146 reflects the optical path onto to the target surface 120. Its fourth (transmitting) surface 148 provides the window to the target surface 120.

The third (half-reflecting) surface 146 is partially reflective and partially transmissive (e.g. 50%) to allow an illumination source 88 behind the third surface to illuminate the target surface 120. This is discussed in more detail in subsequent sections.

The fourth (transmitting) surface 148 is anti-reflection coated to minimise internal reflection of the illumination, as well as to maximise capture efficiency. The first (transmitting) surface 142 is also ideally anti-reflection coated to maximise capture efficiency and minimise stray light reflections.

The iPhone 4 camera 80 has a 4 mm focal-length lens with auto-focus, a 1.375 mm aperture and a 2592×1936 pixel image sensor. The pixel size is 1.6 um×1.6 um. The auto-focus range accommodates object distances from a little less than 100 mm to infinity, thus giving image distances ranging from 4 mm to 4.167 mm.

At the blue end of the spectrum (nominally 480 nm), the paper being imaged is located at the focal point of the folded lens so producing an image at infinity (the lens focal length is 8.8 mm) The iPhone camera lens is focused to infinity thereby producing an image on the camera image sensor. The ratio of folded lens and iPhone camera lens focal lengths gives an imaged area at the surface of 6 mm×6 mm.

At the NIR end of the spectrum (810 nm), the lower refractive index of the folded lens (the lens focal length is 9.03 mm) produces a virtual image of the surface within the auto-focus range of the iPhone camera. In this way the chromatic aberration of the folded lens is corrected.

Also, since the focal length of the folded lens is slightly longer at 810 nm than at 480 nm, the field of view is larger than 6 mm×6 mm at 810 nm.

The optical thickness of the folded component 140 provides sufficient distance to allow a 6 mm×6 mm field of view to be imaged with a minimal standoff (˜5.29 mm)

The side faces (not optically ‘active’ in this design) may have a polished, non-diffuse finish with black paint to block any external light and to control the direction of stray reflections.

### 9.7 Use of Smartphone Flash Illumination

As noted above, the third (half-reflecting) surface 146 is partially reflective and partially transmissive (e.g. 50%) to allow an illumination source 88 behind the third surface to illuminate the target surface 120.

The illumination source 88 may simply be the flash (or ‘torch’) of the smartphone (i.e. iPhone 4 in this case).

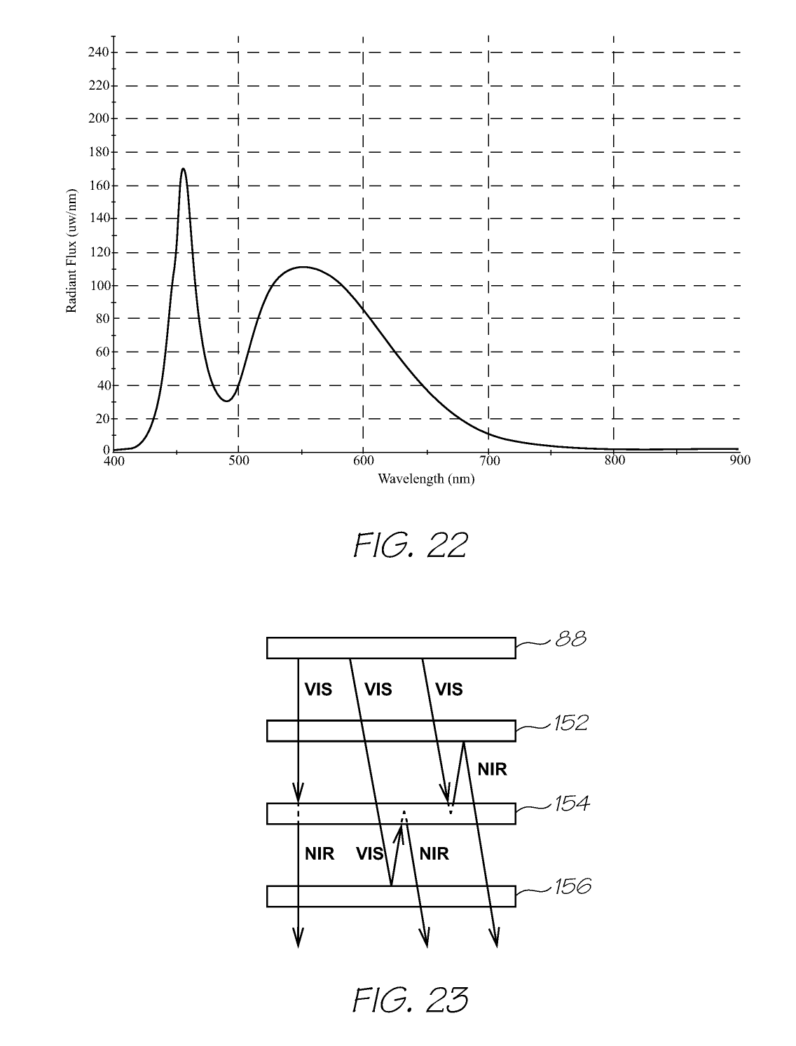

A smartphone flash typically incorporates one or more ‘white’ LEDs, i.e. blue LEDs with a yellow phosphor. FIG. 22 shows a typical emission spectrum (from the iPhone 4 flash).

The timing and duration of flash illumination can generally be controlled from application software, as is the case on the iPhone 4.

Alternatively the illumination source may be one or more LEDs placed behind the third surface, controlled as previously discussed.

### 9.8 Use of Phosphor to Convert Flash Spectrum

If the desired illumination spectrum differs from the spectrum available from the in-built flash, then it is possible to convert some of the flash illumination using one or more phosphors. The phosphor is chosen so that it has an emission peak corresponding to the desired emission peak, an excitation spectrum as closely matched to the flash illumination spectrum as possible, and an adequate conversion efficiency. Both fluorescing and phosphorescing phosphors may be used.

With reference to the white LED spectrum shown in FIG. 22, the ideal phosphor (or mixture of phosphors) would have excitation peaks corresponding to the blue and yellow emissions peaks of the white LED, i.e. around 460 nm and 550 nm respectively.

The use of lanthanide-doped oxides to down-convert visible wavelengths is typical. For example, for the purposes of producing NIR illumination, LaPO₄:Pr produces continuous emission between 750 nm and 1050 nm, with peak emission at an excitation wavelength of 476 nm [Hebbink, G. A., et al, “Lanthanide(III)-Doped Nanoparticles That Emit in the Near-Infrared”, Advanced Materials, Volume 14, Issue 16, pp. 1147-1150, August 2002].

The lower the overall conversion efficiency the longer the required flash duration (and exposure time).

A phosphor may be placed between ‘hot’ and ‘cold’ mirrors to increase conversion efficiency. FIG. 23 illustrates this configuration for visible-to-NIR down-conversion.

An NIR (‘hot’) mirror 152 is placed between the light source 88 and a phosphor 154. The hot mirror 152 transmits visible light and reflects long-wavelength NIR-converted light back towards the target surface. A VIS (‘cold’) mirror 156 is placed between the phosphor 154 and the target surface. The cold mirror 156 reflects short-wavelength un-converted visible light back towards the phosphor 154 for a second chance at being converted.

A phosphor will typically pass a proportion of the source illumination, and may have undesired emission peaks. To restrict the target illumination to desired wavelengths, in the absence of a wavelength-specific mirror between the phosphor and the target, a suitable filter may be deployed either between the phosphor and the target or between the target and the image sensor. This may be a short-pass, band-pass or long-pass filter depending on the relationship between the source and target illumination.

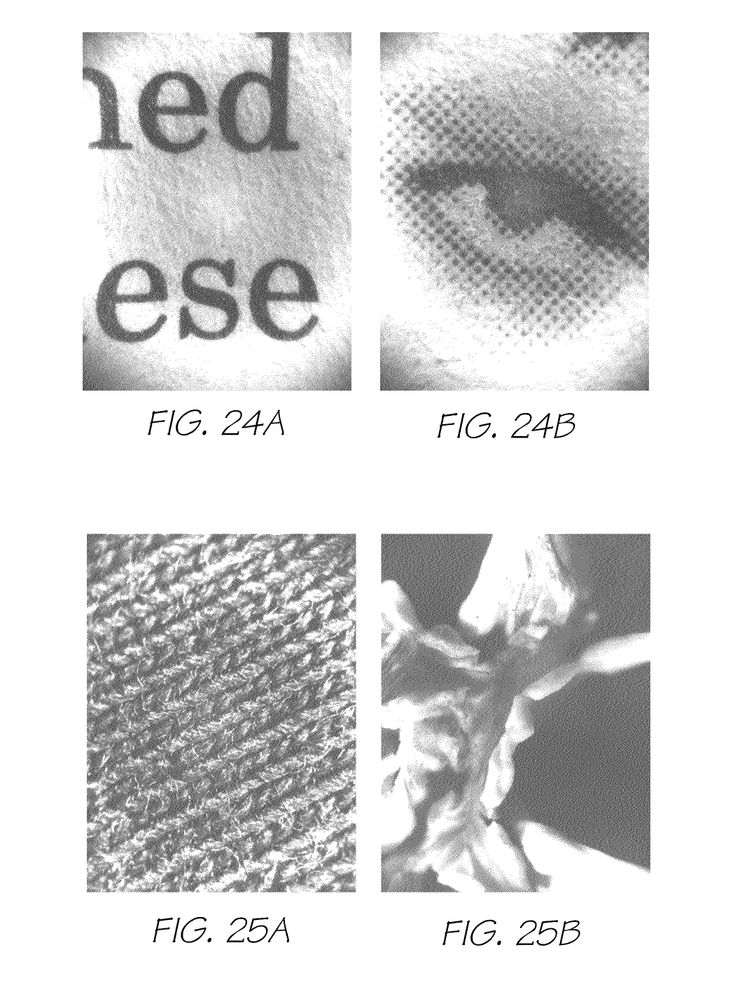

FIGS. 24A and 24B show sample images of printed surfaces captured using an iPhone 3GS and the microscope accessory described in Section 9. FIGS. 25A and 25B show sample images of 3D objects captured using an iPhone 3GS and the microscope accessory described in Section 9.

### 10 Netpage Augmented Reality Viewer

### 10.1 Overview

The Netpage Augmented Reality (AR) Viewer supports Netpage-Viewer-style interaction (as described in U.S. Pat. No. 6,788,293) via a standard smartphone (or similar handheld device) and a standard printed page (e.g. an offset-printed page).

The AR Viewer does not require special inks (e.g. IR) and does not require special hardware (e.g. a Viewer attachment, such as the microscope accessory 100).

The AR Viewer uses the same document markup and supports the same interactivity as the contact Viewer (U.S. Pat. No. 6,788,293).

The AR Viewer has lower barriers to adoption compared with the contact Viewer and so represents an entry-level and/or stepping-stone solution.

### 10.2 Operation

The Netpage AR Viewer consists of a standard smartphone 70 (or similar handheld device) running the AR Viewer software.

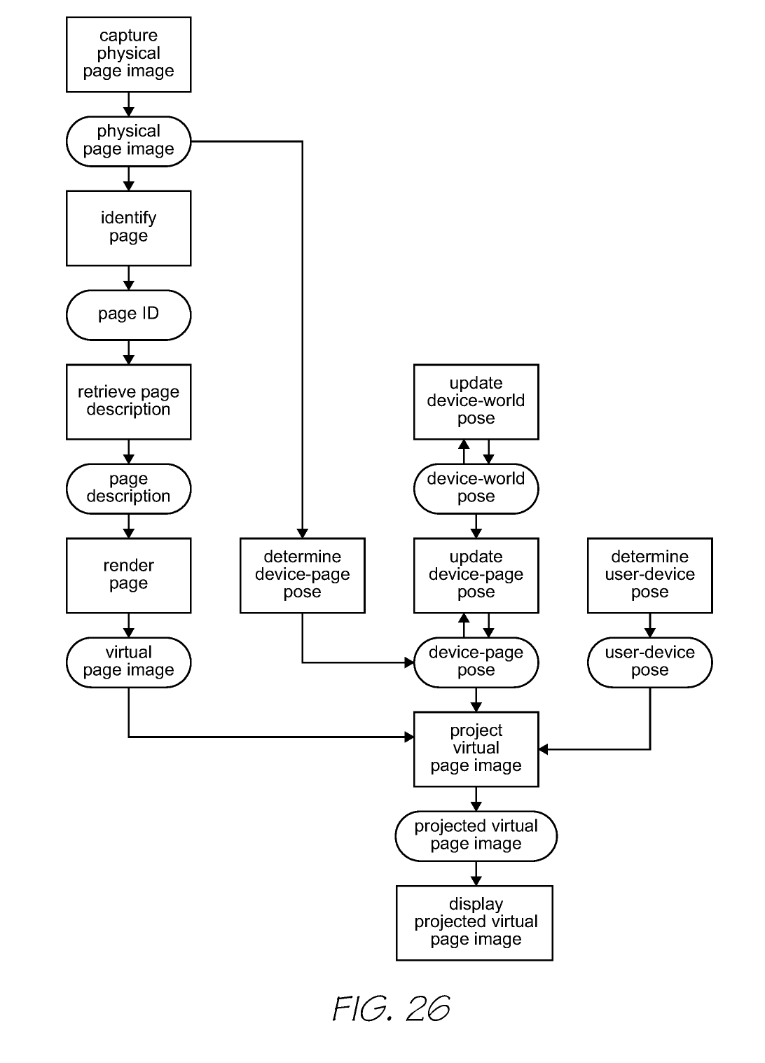

The operation of the Netpage AR Viewer is illustrated in FIG. 26, and is described in the following sections.

### 10.2.1 Capture Physical Page Image

As the user moves the device above a physical page of interest, the Viewer software captures images of the page via the device's camera.

### 10.2.2 Identify Page

The AR Viewer software identifies the page from information printed on the page and recovered from the physical page image. This information may consist of a linear or 2D barcode; a Netpage Pattern; a watermark encoded in an image on the page; or portions of the page content itself, including text, images and graphics.

The page is identified by a unique page ID. This Page ID may be encoded in a printed barcode, Netpage Pattern or watermark, or may be recovered by matching features extracted from the printed page content to corresponding features in an index of pages.

The most common technique is to use SIFT (Scale-Invariant Feature Transform), or a variant thereof, to extract scale-invariant and rotation-invariant features from both the set of target documents to build a feature index of pages, and from each query image to allow feature matching. OCR as described in Section 5.2 may also be used.

The page feature index may be stored locally on the device and/or on one or more network servers accessible to the device. For example, a global page index may be stored on network servers, while portions of the index pertaining to previously-used pages or documents may be stored on the device. Portions of the index may be automatically downloaded to the device for publications that the user interacts with, subscribes to or that the user manually downloads to the device.

### 10.2.3 Retrieve Page Description

Each page has a page description which describes the printed content of the page, including text, images and graphics, and any interactivity associated with the page, such as hyperlinks.

Once the AR Viewer software has identified the page it uses the Page ID to retrieve the corresponding page description.

As shown in FIG. 28, the page ID is either a page instance ID that identifies a unique page instance, or a page layout ID that identifies a unique page description that is shared by a number of identical pages. In the former case a page instance index provides the mapping from page instance ID to page layout ID.

The page description may be stored locally on the device and/or on one or more network servers accessible to the device. For example, a global page description repository may be stored on network servers, while portions of the repository pertaining to previously-used pages or documents may be stored on the device. Portions of the repository may be automatically downloaded to the device for publications that the user interacts with, subscribes to or that the user manually downloads to the device.

### 10.2.4 Render Page

Once the AR Viewer software has retrieved the page description it renders (or rasterizes) the page to a virtual page image, in preparation for display on the device screen.

### 10.2.5 Determine Device-Page Pose

The AR Viewer software determines the pose, i.e. 3D position and 3D orientation, of the device relative to the page from the physical page image, based on the perspective distortion of known elements on the page. The known elements are determined from the rendered page image having no perspective distortion.

The determined pose does not need to be highly accurate, since the AR Viewer software displays a rendered image of the page rather than the physical page image.

### 10.2.6 Determine User-Device Pose

The AR Viewer software determines the pose of the user relative to the device, either by assuming that the user is at a fixed position or by actually locating the user.

The AR Viewer software can assume the user is at a fixed position relative to the device (e.g. 300 mm normal to the centre of the device screen), or at a fixed position relative to the page (e.g. 400 mm normal to the centre of the page).

The AR Viewer software can determine the actual location of the user relative to the device by locating the user in an image captured via the front-facing camera of the device. A front-facing camera is often present in a smartphone to allow video calling.

The AR Viewer software may locate the user in the image using standard eye-detection and eye-tracking algorithms (Duchowski, A. T., Eye Tracking Methodology: Theory and Practice, Springer-Verlag 2003).

### 10.2.7 Project Virtual Page Image

Once it has determined both the device-page and user-device poses, the AR Viewer software projects the virtual page image to produce a projected virtual page image suitable for display on the device screen.

The projection takes into account both the device-page and user-device poses so that when the projected virtual page image is displayed on the device screen and is viewed by the user according to the determined user-device pose then the displayed image appears as a correct projection of the physical page onto the device screen, i.e. the screen appears as a transparent viewport onto the physical page.

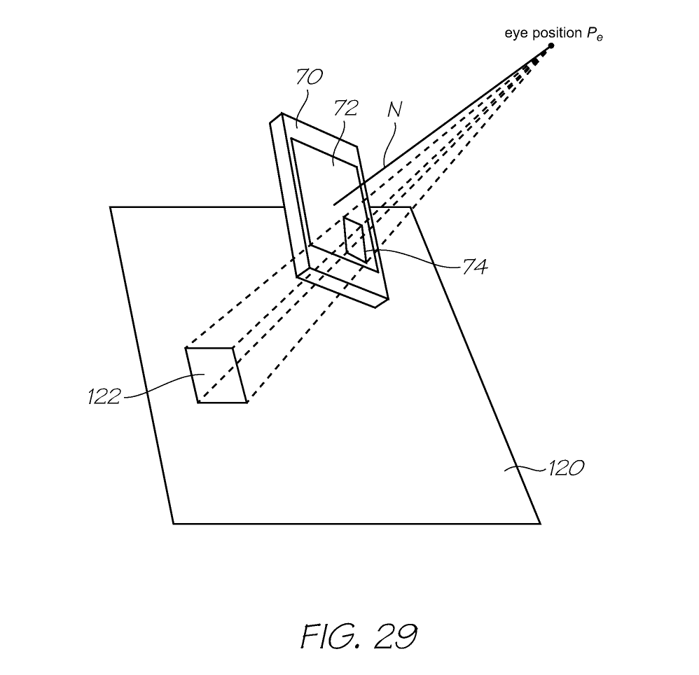

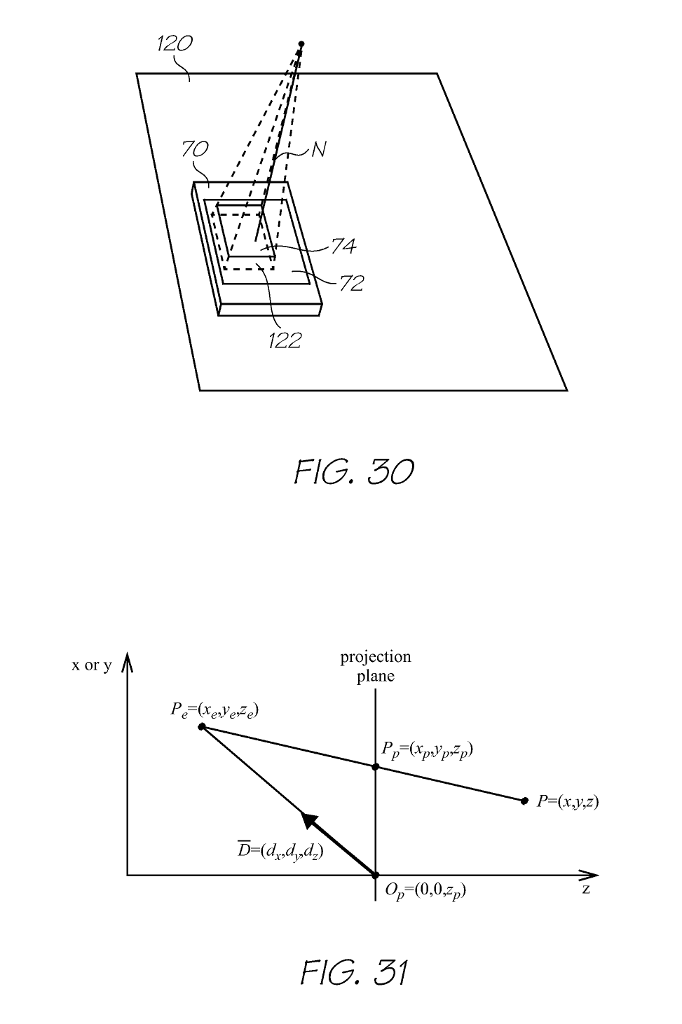

FIG. 29 shows an example of the projection when the device is above the page. A printed graphic element 122 on the page 120 is displayed by the AR Viewer Software on the display screen 72 of the smartphone 70, as a projected image 74 in accordance with the estimated device-page and user-device poses. In FIG. 29, Pₑ represents the eye position and N represents a line normal to the plane of the screen 72. FIG. 30 shows an example of the projection when the device is resting on the page.

Section 10.5 describes the projection in more detail.

### 10.2.8 Display Projected Virtual Page Image

The AR Viewer software clips the projected virtual page image to the bounds of the device screen and displays the image on the screen.

### 10.2.9 Update Device-World Pose

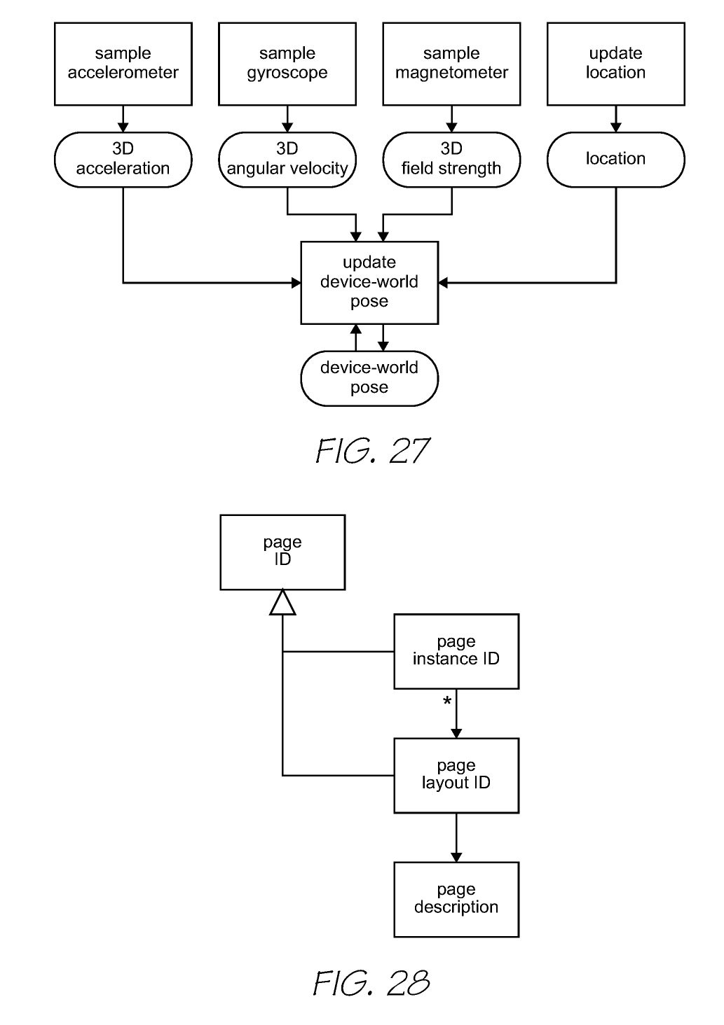

Referring to FIG. 27, the AR Viewer software optionally tracks the pose of the device relative to the world at large using any combination of the device's accelerometers, gyroscopes, magnetometers, and physical location hardware (e.g. GPS).

Double integration of the 3D acceleration signals from the 3D accelerometers yields a 3D position.

Integration of the 3D angular velocity signals from the 3D gyroscopes yields a 3D angular position.

The 3D magnetometers yields a 3D field strength, which when interpreted according to the absolute geographic location of the device, and hence the expected inclination of the magnetic field, yields an absolute 3D orientation.

### 10.2.10 Update Device-Page Pose

The AR Viewer software determines a new device-page pose whenever it can from a new physical page image. Likewise it determines a new Page ID whenever it can.

However, to allow smooth changes in the projection of the virtual page image displayed on the device screen as the user moves the device relative to the page, the Viewer software updates the device-page using relative changes detected in the device-world pose. This assumes that the page itself remains stationary relative to the world at large, or at least is travelling at a constant velocity which represents a low-frequency DC component of the device-world pose signal which can be easily suppressed.

When the device is placed close to or on the surface of a page of interest, the device camera may no longer be able to image the page and thus the device-page pose can no longer be accurately determined from the physical page image. The device-world pose may then provide the sole basis for tracking the device-page pose.

The absence of a physical page image due to close page proximity or contact can also be used as the basis for assuming that the distance from the page to the device is small or zero. Similarly, the absence of an acceleration signal can be used as the basis for assuming that the device is stationery and therefore in contact with the page.

### 10.3 Usage

A user of the Netpage AR Viewer starts by launching the AR Viewer software application on the device and then holding the device above the page of interest.

The device automatically identifies the page and displays a pose-appropriate projected page image. Thus the device appears as if transparent.

The user interacts with the page on the touchscreen, e.g. by touching a hyperlink to display a linked web page on the device.

The user moves the device above, or on, the page of interest to bring a particular area of the page into the interactive view provided by the Viewer.

### 10.4 Alternative Configuration

In an alternative configuration, the AR Viewer software displays the physical page image rather than a projected virtual page image. This has the advantage that the AR Viewer software no longer needs to retrieve and render the graphical page description, and can thus display the page image before it has been identified. However, the AR Viewer software still needs to identify the page and retrieve the interactive page description in order to allow interactions with the page.

A disadvantage of this approach is that the physical page image captured by the camera does not look like the page seen through the screen of the device: the centre of the physical page image is offset from centre of screen; the scale of the physical page image is incorrect except at particular distances from the page; and the quality of physical page image may be poor (e.g. poorly lit, low resolution, etc.).

Some of these issues may be addressed by transforming the physical page image to appear as if seen through the screen of the device. However, this would generally require a wider-angle camera than is available in typical target devices.

The physical page image may also need to be augmented with rendered graphics from the page description.

### 10.5 Projection of Virtual Page Image

FIG. 30 illustrates the projection of a 3D point P onto a projection plane parallel to the x-y plane at distance of zₚ from the x-y plane, according to a 3D eye position Pₑ.

In relation to the Viewer, the projection plane is the screen of the device; the eye position Pₑ is the determined eye position of the user, as embodied in the user-device pose; and the point P is a point within the virtual page image (previously transformed into the coordinate space of the device according to the device-page pose).

The following equations show the calculation of the coordinates of the projected point Pₚ.

$${\overline{V}}_{e} = {P}_{e} - {O}_{p}$$

$$Q = \vert {\overline{V}}_{e} \vert$$

$$\overline{D} = ( {d}_{x} , {d}_{y} , {d}_{z} ) = \frac{{\overline{V}}_{e}}{Q}$$

$$R = \frac{{z}_{p} - z}{{d}_{z}}$$

$${x}_{p} = \frac{x + {Rd}_{x}}{\frac{R}{Q} + 1}$$

$${y}_{p} = \frac{y + {Rd}_{y}}{\frac{R}{Q} + 1}$$

The present invention has been described with reference to a preferred embodiment and number of specific alternative embodiments. However, it will be appreciated by those skilled in the relevant fields that a number of other embodiments, differing from those specifically described, will also fall within the \ scope of the present invention. Accordingly, it will be understood that the invention is not intended to be limited to the specific embodiments described in the present specification, including documents incorporated by cross-reference as appropriate. The scope of the invention is only limited by the attached claims.

1. A hybrid system for identifying a printed page, said system comprising:
the printed page having human-readable content and a coding pattern printed in every interstitial space between portions of human-readable content, said coding pattern identifying a page identity, said coding pattern being either absent from said portions of human-readable content or unreadable when superimposed with said human-readable content;
a handheld device for overlaying and contacting said printed page, said device comprising:
a camera for capturing page fragment images; and
a processor configured for:
decoding the coding pattern and determining the page identity in the event that the coding pattern is visible in and decodable from the captured page fragment image; and
otherwise initiating at least one of OCR and SIFT techniques to identify said page from text and/or graphic features in said captured page fragment image.

2. The system of claim 1, wherein the coding pattern has less than 4% coverage on said page.

3. The system of claim 1, wherein the coding pattern is printed with yellow ink, said coding pattern being substantially invisible to a human eye by virtue of a relatively low luminance of yellow ink.

4. The system of claim 1, wherein said handheld device is a tablet-shaped device having a display screen on a first face and the camera positioned on an opposite second face, and wherein said second face is in contact with a surface of the printed page when said device overlays said page.

5. The system of claim 1, wherein a pose of the camera is fixed and normal relative to the surface when said device overlays said printed page.

6. The system of claim 1, wherein each captured page fragment image has substantially consistent scale and illumination with no perspective distortion.

7. The system of claim 1, wherein a field of view of the camera has an area of less than about 100 square millimeters.

8. The system of claim 1, wherein the camera has an object distance of less than 10 mm.

9. The system of claim 1, wherein said device is configured for retrieving a page description corresponding to said page.

10. The system of claim 1, wherein said coding pattern identifies a plurality of coordinate locations on said page and said processor is configured for determining a position of said device relative to said page.

11. The system of claim 1, wherein said coding pattern is printed only in interstitial spaces between lines of text.

12. The system of claim 11, wherein said device further comprises means for sensing motion.

13. The system of claim 12, wherein said means for sensing motion utilizes at least one of:
an optical mouse technique; detecting motion blur; doubly integrating accelerometer signals; and
decoding a coordinate grid pattern.

14. The system of claim 12, wherein said device is configured for moving across said page, said camera is configured for capturing a plurality of page fragment images at a plurality of different capture points, and said processor is configured for initiating an OCR technique comprising the steps of:
measuring a displacement or direction of movement using said motion sensor;
performing OCR on each captured page fragment image to identify a plurality of glyphs in a two-dimensional array;
creating a glyph group key for each page fragment image, said glyph group key containing n×m glyphs, where n and m are integers from 2 to 20;
looking up each created glyph group key in an inverted index of glyph group keys;
comparing the displacement or direction between glyph group keys in said inverted index with a measured displacement or direction between the capture points for corresponding glyph group keys created using said OCR; and
identifying said page using said comparison.

15. The system of claim 14, wherein said OCR technique utilizes contextual information to identify a set of candidate pages.

16. The system of claim 15, wherein said contextual information comprises a page identity determined from the coding pattern of a page with which a user has immediately or recently interacted.

17. The system of claim 15, wherein said contextual information comprises at least one of:
publications associated with a user; recently published publications; publication printed in a user's preferred language; publications associated with a geographic location of a user.

18. A printed page having human-readable lines of text and a coding pattern printed in every interstitial space between said lines of text, said coding pattern identifying a page identity and being printed with a yellow ink, said coding pattern being either absent from said lines of text or unreadable when superimposed with said text.

19. The printed page of claim 18, wherein said coding pattern identifies a plurality of coordinate locations on said page.

20. The printed page of claim 18, wherein said coding pattern is printed only in interstitial spaces between lines of text.
